(19) United States
(12) Patent Application Publication
(10) Pub. No.: US 2025/0262862 A1
(43) Pub. Date: Aug. 21, 2025

(54) LIQUID EJECTING DEVICE

(71) Applicant: SEIKO EPSON CORPORATION, Tokyo (JP)

(72) Inventor: Tomohiro NUMAJIRI, SHIOJIRI-SHI (JP)

(21) Appl. No.: 19/057,526

(22) Filed: Feb. 19, 2025

(30) Foreign Application Priority Data
Feb. 21, 2024 (JP) 2024-024525

(51) Int. Cl. B41J 2/165

(52) U.S. Cl. CPC B41J 2/16544; B41J 2002/1655; B41P 2235/242; B41P 2235/244

(57) ABSTRACT

A liquid ejecting device includes a liquid ejecting unit, a maintenance unit, and a raising and lowering mechanism. The liquid ejecting unit is capable of ejecting liquid. The maintenance unit performs maintenance of the liquid ejecting unit. The raising and lowering mechanism raises and lowers the maintenance unit between a first position and a second position lowered than the first position. The raising and lowering mechanism includes a counterweight and a coupling portion. Both ends of the coupling portion are coupled to coupling destinations so as to raise and lower the counterweight and the maintenance unit in opposite directions to each other via a pulley.

The present application is based on, and claims priority from JP Application Serial Number 2024-024525, filed Feb. 21, 2024, the disclosure of which is hereby incorporated by reference herein in its entirety.

### BACKGROUND

### 1. Technical Field

The present disclosure relates to a liquid ejecting device including a maintenance unit that performs maintenance of a liquid ejecting unit that ejects liquid.

### 2. Related Art

For example, JP-A-2022-12259 discloses a liquid ejecting device (for example, a recording device) that performs printing on a medium such as paper by ejecting liquid from a liquid ejecting unit (for example, a recording head) capable of ejecting liquid such as ink. The liquid ejecting device includes a maintenance unit that performs maintenance of the liquid ejecting unit. The maintenance unit includes a wiping device that performs maintenance (for example, wiping) on the nozzle surface of the liquid ejecting unit using a cleaning cloth (for example, a wiping member) fed from a roll-shaped cloth roll. This type of the wiping device includes a feeding unit and a winding unit. When the winding unit winds the cleaning cloth, a new cloth region is fed out from the cloth roll.

However, in the liquid ejecting device described in JP-A-2022-12259, when all of the cloth rolls in the feeding unit are fed, it is necessary to perform a replacement operation of removing the used cloth roll wound around the winding unit and setting a new cloth roll in the feeding unit. Alternatively, the maintenance unit itself needs to be replaced with a new maintenance unit. However, in the liquid ejecting device described in JP-A-2022-12259, there is room for improvement in terms of replaceability of consumables used for maintenance. Maintenance using consumables such as cloth is not limited to wiping, and includes cleaning and the like. In addition, there is also a case where a person such as a user or a service person needs to access the maintenance unit in order to perform a component replacement operation, a cleaning operation, or the like without being limited to the replacement operation of the consumables. As described above, there is room for improvement in accessibility when a person or the like performs a predetermined operation on the maintenance unit. Therefore, it is desired to improve usability for a person or the like who accesses the maintenance unit.

### SUMMARY

According to an aspect of the disclosure, there is provided a liquid ejecting device including a liquid ejecting unit configured to eject liquid, a maintenance unit configured to perform maintenance of the liquid ejecting unit, and a raising and lowering mechanism configured to raise and lower the maintenance unit between a first position and a second position lowered than the first position, wherein the raising and lowering mechanism includes a counterweight, and a coupling portion having both ends coupled to a coupling destination to raise and lower the counterweight and the maintenance unit in opposite directions to each other via a pulley.

### BRIEF DESCRIPTION OF THE DRAWINGS

FIG. 1 is a schematic side view illustrating a liquid ejecting device according to an embodiment.

FIG. 2 is a partial side view illustrating the liquid ejecting device.

FIG. 3 is a schematic view illustrating a maintenance unit and a raising and

lowering mechanism.

FIG. 4 is a schematic view illustrating the maintenance unit and the raising and lowering mechanism.

FIG. 5 is a side view illustrating the maintenance unit and the raising and

lowering mechanism.

FIG. 6 is a rear view illustrating the maintenance unit raised to a first position and the raising and lowering mechanism.

FIG. 7 is a rear view illustrating the maintenance unit lowered to a second position and the raising and lowering mechanism.

FIG. 8 is a perspective view illustrating the maintenance unit slid to a working position and the raising and lowering mechanism.

FIG. 9 is a front view illustrating the maintenance unit raised to the first position and the raising and lowering mechanism.

FIG. 10 is a partial rear view of the maintenance unit regulated to the first position by a second regulating unit.

FIG. 11 is a front view for explaining the operation of a positioning assist mechanism.

FIG. 12 is a front view for explaining the operation of the positioning assist mechanism.

FIG. 13 is a rear view for explaining the operation of a holding unit.

FIG. 14 is a rear view for explaining the operation of the holding unit.

FIG. 15 is a partial perspective view illustrating the maintenance unit sliding to the working position and the raising and lowering mechanism.

FIG. 16 is a side view illustrating a wiping unit, which is an example of the maintenance unit, and the raising and lowering mechanism.

FIG. 17 is a schematic view illustrating a maintenance unit and a raising and lowering mechanism in a modification example.

FIG. 18 is a schematic view illustrating a maintenance unit and a raising and lowering mechanism in a modification example different from that of FIG. 17.

FIG. 19 is a schematic view illustrating a maintenance unit and a raising and lowering mechanism in a modification example different from that of FIG. 18.

FIG. 20 is a schematic view illustrating a maintenance unit and a raising and lowering mechanism in a modification example different from that of FIG. 19.

### DESCRIPTION OF EMBODIMENTS

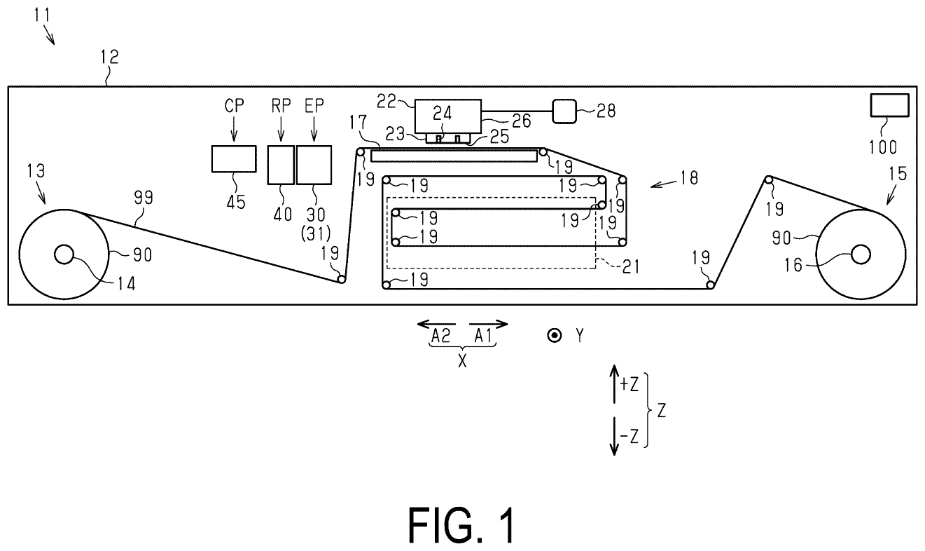

Below, an embodiment of a liquid ejecting device will be described with reference to the drawings. A liquid ejecting device 11 illustrated in FIG. 1 in the present embodiment is, for example, an ink jet type printer that prints an image such as a character or a photograph by ejecting ink, which is an example of a liquid, onto a medium such as paper or fabric.

### Liquid Ejecting Device 11

In the liquid ejecting device 11 illustrated in FIG. 1, three directions intersecting with each other (for example, orthogonal to each other) are indicated by an XYZ coordinate system, and are respectively referred to as an X direction, a Y direction, and a Z direction. The X direction and the Y direction intersect (for example, are orthogonal to) each other in, for example, a horizontal plane. The X direction is a scanning direction in which a liquid ejecting unit 22 moves in the liquid ejecting device 11, and thus is also referred to as a scanning direction X. The X direction is also a direction in which a portion of a medium 99 on which printing is performed by the liquid ejecting unit 22 ejecting liquid is transported. The Y direction is a direction that intersects (for example, is orthogonal to) the scanning direction X on the horizontal plane. The Z direction is a direction parallel to a vertical direction, and is therefore also referred to as a vertical direction Z. The vertical direction Z includes an upward direction+Z and a downward direction-Z.

As illustrated in FIG. 1, the liquid ejecting device 11 includes a housing 12. The liquid ejecting device 11 includes a medium feeding unit 13. The medium feeding unit 13 is configured to feed the medium 99. The medium feeding unit 13 is accommodated in, for example, the housing 12. The medium feeding unit 13 includes a feeding shaft 14. The feeding shaft 14 rotatably holds a roll body 90 around which the medium 99 is wound. The feeding shaft 14 holds the medium 99 before printing. As the feeding shaft 14 rotates, the medium 99 is fed from the medium feeding unit 13. The feeding shaft 14 may be driven to rotate by a motor, or may be rotated in a driven manner by the medium 99 being pulled.

The liquid ejecting device 11 includes a medium winding unit 15. The medium winding unit 15 is configured to wind the medium 99. The medium winding unit 15 is accommodated, for example, in the housing 12. The medium winding unit 15 includes a winding shaft 16. Similarly to the feeding shaft 14, the winding shaft 16 rotatably holds the roll body 90. The winding shaft 16 holds the medium 99 after printing. As the winding shaft 16 rotates, the medium winding unit 15 winds the medium 99. The winding shaft 16 is driven to rotate, for example, by a motor.

The liquid ejecting device 11 includes a medium support unit 17. The medium support unit 17 supports the medium 99. The medium support unit 17 is accommodated in the housing 12, for example. The medium support unit 17 supports, for example, the medium 99 from below. The medium support unit 17 supports the medium 99 in the course from when the medium 99 is fed from the medium feeding unit 13 to when the medium 99 is wound around the medium winding unit 15. Printing is performed on a region of the medium 99 supported by the medium support unit 17.

The medium support unit 17 may be, for example, a platen having a rectangular plate shape extending in the scanning direction X. The platen may have a plurality of ribs that support the medium 99. The platen may have an absorbing member capable of absorbing liquid such as ink ejected from the liquid ejecting head 23 to a place other than the medium 99.

The liquid ejecting device 11 includes a transport unit 18. The transport unit 18 is configured to transport the medium 99. The transport unit 18 is accommodated in, for example, the housing 12. The transport unit 18 transports the medium 99 from the medium feeding unit 13 toward the medium winding unit 15. For example, the transport unit 18 transports the medium 99 on the medium support unit 17 toward a first direction A1. The transport unit 18 transports the medium 99 intermittently, for example. Specifically, the transport unit 18 stops while the liquid is ejected to the region of the medium 99 supported by the medium support unit 17. The transport unit 18 transports the medium 99 after the liquid is ejected to the region of the medium 99 supported by the medium support unit 17. The transport unit 18 is not limited to a long medium 99 that is continuous from the roll body 90, and may transport single sheets of the medium 99.

The transport unit 18 includes one or more transport rollers 19. For example, the transport roller 19 is located in the housing 12, for example. The transport roller 19 rotates to transport the medium 99. The medium 99 is wound over the transport roller 19. The transport rollers 19 may sandwich the medium 99. The transport roller 19 rotates to transport the medium 99. The transport roller 19 includes, for example, a roller that is driven to rotate by a motor. A transport path of the medium 99 is formed in the housing 12 by the transport roller 19.

The liquid ejecting device 11 includes a drying unit 21. The drying unit 21 is configured to dry the medium 99 after printing. The drying unit 21 dries the medium 99 in the course in which the medium 99 is transported from the medium support unit 17 to the medium winding unit 15. The drying unit 21 is located, for example, inside the housing 12. The drying unit 21 is located, for example, immediately below the medium support unit 17. The drying unit 21 may include a heater that heats the medium 99. The drying unit 21 may include a blower that blows a gas onto the medium 99.

The liquid ejecting device 11 includes the liquid ejecting unit 22. The liquid ejecting unit 22 is configured to be capable of ejecting liquid. The liquid ejecting unit 22 ejects liquid onto the medium 99. The liquid ejecting unit 22 includes a liquid ejecting head 23. The liquid ejecting head 23 has a plurality of nozzles 24. The liquid ejecting head 23 has a nozzle surface 25 capable of facing a support surface (for example, an upper surface) of the medium support unit 17. The plurality of nozzles 24 are open in the nozzle surface 25.

The liquid ejecting unit 22 of the present embodiment reciprocates in the scanning direction X. The liquid ejecting unit 22 includes a carriage 26 configured to reciprocate in the scanning direction X. The liquid ejecting head 23 is mounted on the carriage 26. The liquid ejecting unit 22 passes through a position facing the medium support unit 17 by reciprocating in the scanning direction X. The liquid ejecting unit 22 is located, for example, above the medium support unit 17.

The scanning direction X includes the first direction A1 and the second direction A2. The second direction A2 is the opposite direction to the first direction A1. In the liquid ejecting device 11, a direction in which the carriage 26 moves coincides with a direction in which the medium 99 moves on the medium support unit 17. Thus, the liquid ejecting device 11 is a lateral printer. In the case of the lateral printer, the carriage 26 may also be movable in a sub-scanning direction Y orthogonal to the scanning direction X (main scanning direction X). The liquid ejecting device 11 may be a serial printer in which the medium 99 is transported in a direction different from the scanning direction X. In addition, the liquid ejecting device 11 may be a serial printer in which a direction different from the X direction which is a direction in which the medium 99 is transported is a scanning direction in which the carriage 26 moves.

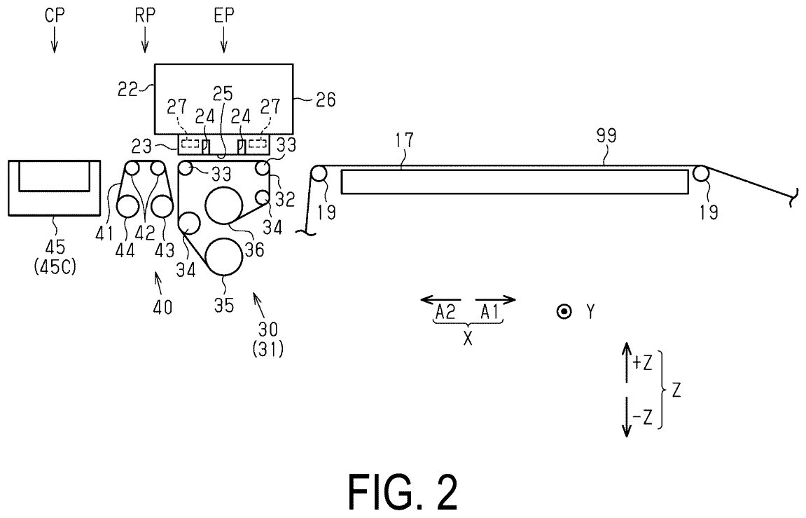

As illustrated in FIG. 2, the liquid ejecting unit 22 performs printing on the medium 99 by ejecting liquid onto the medium 99. The liquid ejecting unit 22 has the nozzle surface 25 in which one or more nozzles 24 are open. The liquid ejecting unit 22 ejects liquid from the nozzle 24.

The liquid ejecting unit 22 includes one or more piezoelectric elements 27. The liquid ejecting unit 22 has the same number of piezoelectric elements 27 as that of the nozzles 24. The piezoelectric element 27 changes the pressure in the nozzle 24 when a voltage is applied thereto. When the piezoelectric element 27 changes the pressure in the nozzle 24, the liquid is ejected from the nozzle 24.

The piezoelectric element 27 can change the pressure in the nozzle 24 so that liquid is not ejected from the nozzle 24. In other words, the piezoelectric element 27 can vibrate the liquid in the nozzle 24 so that liquid is not ejected from the nozzle 24 by changing the pressure in the nozzle 24. In this manner, the liquid ejecting unit 22 can perform micro-vibration for vibrating the liquid in the nozzle 24. The liquid in the nozzle 24 is stirred by the micro-vibration. As a result, thickening of the liquid in the nozzle 24 is eliminated. The liquid ejecting unit 22 appropriately performs the micro-vibration, for example, before printing, during printing, or the like. The micro-vibration is performed in a state where the liquid ejecting unit 22 is stopped.

The liquid ejecting unit 22 ejects the liquid onto a region of the medium 99 supported by the medium support unit 17. The liquid ejecting unit 22 is, for example, a line head capable of ejecting liquid all at once across the width of the medium 99. The liquid ejecting unit 22 reciprocates in the scanning direction X together with the carriage 26. Accordingly, the liquid ejecting unit 22 can eject the liquid over the entire region of the medium 99 supported by the medium support unit 17.

The liquid ejecting unit 22 is displaced to a plurality of positions by moving in the scanning direction X. The liquid ejecting unit 22 is displaced not only to a position facing the medium support unit 17 but also to a position not facing the medium support unit 17. The liquid ejecting unit 22 may reciprocate between positions facing the medium support unit 17 during printing, or may also reciprocate between positions not facing the medium support unit 17 in an operation different from printing.

As illustrated in FIG. 1, the liquid ejecting device 11 includes a pressurizing unit 28. The pressurizing unit 28 is configured to pressurize the inside of the liquid ejecting unit 22. The pressurizing unit 28 is coupled to the liquid ejecting unit 22. The pressurizing unit 28 is, for example, a pump. The pressurizing unit 28 supplies the liquid to a flow path (not illustrated) communicating with the nozzle 24 by pressurization. The liquid ejecting unit 22 is coupled to a liquid supply source (not illustrated) such as an ink cartridge or an ink tank through a flow path. The pressurizing unit 28 supplies, from a liquid supply source, an amount of liquid corresponding to an amount of liquid consumed by the liquid ejecting unit 22 ejecting the liquid from the nozzle 24, to a flow path (not illustrated) communicating with the nozzle 24 by pressurization.

The flow path pressurized by the pressurizing unit 28 may be a circulation flow path passing through the liquid ejecting unit 22. In this case, the pressurizing unit 28 may perform a circulation operation of circulating the liquid in the circulation flow path. The liquid such as ink contains a coloring matter. The coloring matter is, for example, pigment or dye. Depending on a type of liquid, the coloring matter (for example, pigment) may be prone to settling over time. When liquid in which the coloring matter is prone to settling is used as described above, a circulation operation of circulating the liquid through the circulation flow path may be performed. The circulation operation stirs the coloring matter in the liquid, thereby curbing the settling of the coloring matter.

The liquid ejecting device 11 includes a maintenance unit 30. The maintenance unit 30 performs maintenance on the liquid ejecting unit 22. The maintenance performed on the liquid ejecting unit 22 by the maintenance unit 30 is, for example, cleaning. The maintenance unit 30 of the present embodiment is a cleaning unit 31 that performs cleaning as maintenance. The cleaning unit 31 receives the liquid ejected or discharged from the nozzles 24 by the liquid ejecting unit 22 performing cleaning. The cleaning in the present embodiment is an operation in which the liquid ejecting unit 22 ejects or discharges the liquid from the nozzle 24 in order to prevent or eliminate an ejection failure (clogging or the like) of the nozzle 24. In addition, the reception of the liquid in which the liquid ejected or discharged from the nozzle 24 by the cleaning is received by a receiving member 32 (refer to FIG. 2) which will be described below is also included in a part of the cleaning.

The liquid ejecting unit 22 may perform a liquid discharge operation of forcibly discharging the liquid from the nozzle 24 as an example of the cleaning. The liquid ejecting unit 22 may perform flushing as an example of the cleaning. The flushing is a process of ejecting liquid droplets that are not related to printing from all the nozzles 24. That is, the cleaning includes at least one of the liquid discharge processing and the flushing. The cleaning of the present embodiment includes, for example, both the liquid discharge processing and the flushing. Note that the cleaning may be only the liquid discharge processing or only the flushing. In addition, in the present specification, a period in which the liquid discharge operation is performed is referred to as a cleaning period, and a period in which the flushing is performed is referred to as a flushing period. The control unit 100 manages a cleaning time and a flushing time.

When the cleaning time is reached, the liquid ejecting unit 22 moves to a discharge position EP. The discharge position EP is, for example, a position shifted in a second direction A2 from the position facing the medium support unit 17. The liquid ejecting unit 22 forcibly discharges the liquid from the nozzle 24 toward the maintenance unit 30 at the discharge position EP. The maintenance unit 30 receives the liquid discharged from the nozzle 24. In addition, the liquid ejecting unit 22 moves to the discharge position EP at the flushing time. The liquid ejecting unit 22 ejects the liquid from the nozzle 24 toward the maintenance unit 30 at the discharge position EP. In a case where the cleaning is the liquid discharge operation, for example, air bubbles, foreign substances, and the like present in the liquid in the nozzle 24 are discharged together with the liquid (ink). In a case where the cleaning is flushing, for example, the thickened liquid (thickened ink) present in the liquid in the nozzle 24 is ejected from the nozzle 24 by the discharge. In this manner, the nozzle 24 is cleaned by the liquid discharge operation or the flushing, and thus the ejection failure of the nozzle 24 is prevented or eliminated.

The liquid ejecting device 11 includes a wiping unit 40. The wiping unit 40 wipes the nozzle surface 25 by coming into contact with the nozzle surface 25. When the wiping unit 40 wipes the nozzle surface 25, the liquid adhering to the nozzle surface 25 is removed. That is, the wiping unit 40 performs wiping on the liquid ejecting unit 22. The wiping unit 40 wipes the nozzle surface 25 after cleaning, for example. When the cleaning operation is performed, the liquid adheres to the nozzle surface 25 as a result of the liquid being discharged from the nozzle 24. Therefore, it is preferable that the wiping unit 40 wipes the nozzle surface 25 after cleaning. Accordingly, the liquid adhering to the nozzle surface 25 is removed.

The liquid ejecting unit 22 is displaced to a removal position RP facing the wiping unit 40. The removal position RP is a position at which the liquid adhering to the nozzle surface 25 is removed. The removal position RP is, for example, a position where the liquid ejecting unit 22 is shifted in the second direction A2 from a position facing the medium support unit 17.

The wiping unit 40 is arranged with the maintenance unit 30 in the scanning direction X, for example. In one example, the wiping unit 40 is disposed at a position shifted in the second direction A2 from the maintenance unit 30. For the wiping unit 40, for example, when the liquid ejecting unit 22 is located at the removal position RP, the liquid ejecting unit 22 faces the wiping unit 40. The wiping unit 40 comes into contact with the nozzle surface 25, for example, by approaching the liquid ejecting unit 22 at the removal position RP. The wiping unit 40 may come into contact with the nozzle surface 25 by the liquid ejecting unit 22 at the removal position RP approaching the wiping unit 40. The wiping unit 40 wipes the nozzle surface 25 by relatively moving in a direction along the nozzle surface 25 with respect to the liquid ejecting unit 22 in a state of being in contact with the nozzle surface 25.

The liquid ejecting device 11 includes a contact portion 45. The contact portion 45 moisturizes the nozzle 24 by coming into contact with the nozzle surface 25. The contact portion 45 is, for example, a cap 45C. The contact portion 45 forms a space communicating with the nozzle 24 by coming into contact with the nozzle surface 25. That is, the contact portion 45 caps the liquid ejecting unit 22. The nozzle 24 is moisturized by the capping. As a result, concern that clogging occurs in the nozzle 24 is reduced.

The liquid ejecting unit 22 may stand by at a retreat position CP facing the contact portion 45 until printing is started. During the standby, the liquid ejecting unit 22 is displaced to the retreat position CP facing the contact portion 45. The retreat position CP is a position at which the liquid ejecting unit 22 stops in a case where printing is not performed, for example, in a case of waiting for an input of a start signal of a print job. The liquid ejecting unit 22 waits at the retreat position CP when printing is not performed. That is, the retreat position CP is a home position of the liquid ejecting unit 22. The retreat position CP is, for example, a position shifted in the second direction A2 from the position facing the medium support unit 17. When printing is started, for example, when a start signal of a print job is input, the liquid ejecting unit 22 is displaced from the retreat position CP toward the first direction A1 toward the position of the medium support unit 17.

The liquid ejecting unit 22 reciprocates in the scanning direction X. The position of the medium support unit 17 is disposed at a position shifted in the first direction A1 from the maintenance unit 30, the wiping unit 40, and the contact portion 45. At the time of printing, the liquid ejecting unit 22 moves from the retreat position CP to the first direction A1. The liquid ejecting unit 22 moves in the first direction A1 and in the second direction A2 within a range of a position facing the medium support unit 17. For example, the liquid ejecting unit 22 performs printing on a portion of the medium 99 supported by the medium support unit 17 by ejecting droplets of ink or the like from the nozzle 24 in the course of reciprocating within a range facing the medium support unit 17.

In addition, the pressurizing unit 28 forcibly discharges the liquid from the nozzle 24. That is, the pressurizing unit 28 pressurizes the inside of the liquid ejecting unit 22 to perform cleaning in which the liquid is forcibly discharged from the nozzle 24 of the liquid ejecting unit 22. The cleaning is a maintenance for forcibly discharging the liquid from the nozzle 24 to discharge air bubbles, foreign matter, and the like from the nozzle 24 together with the liquid. Therefore, the pressurizing unit 28 causes the liquid ejecting unit 22 to perform cleaning as maintenance.

As illustrated in FIG. 1, the liquid ejecting device 11 includes a control unit 100. The control unit 100 controls the liquid ejecting device 11. The control unit 100 controls, for example, the medium feeding unit 13, the medium winding unit 15, the transport unit 18, the drying unit 21, the liquid ejecting unit 22, the pressurizing unit 28, the maintenance unit 30, the wiping unit 40, the contact portion 45, and the like.

The control unit 100 may execute the circulation operation of circulating the liquid in the circulation flow path passing through the inside of the liquid ejecting unit 22 every predetermined time by controlling the pressurizing unit 28. Through the circulation operation, a settling of coloring matter (for example, pigment) in the liquid is effectively prevented. The control unit 100 may execute the circulation operation after the printing is finished. Accordingly, the next printing is executed smoothly. The control unit 100 may execute the circulation operation when the power supply of the liquid ejecting device 11 is turned on from off. When the power is switched from off to on, the liquid has often remained stagnant for a long time. Therefore, the circulation operation can be used to stir the coloring matter that has settled in the liquid. The control unit 100 may change the length of time for which the circulation operation is continued, or may change the circulation intensity.

The control unit 100 may receive a print job from a host device (not illustrated), which is an example of an external device. The host device may be, for example, a personal computer. The liquid ejecting device 11 may include an operation panel. A print job may be sent to the control unit 100 by a user operating the operation unit of the operation panel. The control unit 100 executes the received print job.

In addition, a linear encoder (not illustrated) for detecting the position of the liquid ejecting unit 22 (carriage 26) in the scanning direction X is provided in the housing 12. The linear encoder outputs a detection signal including a number of pulses proportional to the amount of movement of the liquid ejecting unit 22 in the scanning direction X. The control unit 100 counts the number of pulse edges of the detection signal input from the linear encoder by a counter (not illustrated). The counter is reset when the liquid ejecting unit 22 is at the origin position in the scanning direction X. The control unit 100 acquires the position of the liquid ejecting unit 22 from a count value of the counter. The control unit 100 performs position control and speed control of the liquid ejecting unit 22 based on the detection signal from the linear encoder and the count value of the counter. The control unit 100 performs printing on the medium 99, maintenance of the liquid ejecting unit 22 at a maintenance position MP, and the like by performing position control and speed control of the liquid ejecting unit 22.

### Configuration of Maintenance Unit 30, Wiping Unit 40, and Contact Portion 45

Next, configurations of the maintenance unit 30, the wiping unit 40, and the contact portion 45 will be described in detail with reference to FIG. 2.

The maintenance unit 30 includes a receiving member 32. The receiving member 32 is a member that absorbs liquid. The receiving member 32 is, for example, a cloth. The receiving member 32 receives the liquid ejected or discharged from the nozzle 24 and absorbs the received liquid.

The maintenance unit 30 receives, for example, the liquid ejected from the nozzles 24 by flushing. The flushing is a maintenance process in which liquid is ejected from the nozzle 24 to suppress clogging of the nozzle 24. By the flushing, for example, the thickened liquid (for example, thickened ink) is discharged from the nozzle 24. The flushing is performed by applying a voltage to the piezoelectric element 27. Therefore, the maintenance unit 30 receives the liquid discharged by the flushing as the maintenance. The amount of liquid discharged to the maintenance unit 30 by flushing is smaller than the amount of liquid discharged to the maintenance unit 30 by cleaning.

The maintenance unit 30 is arranged with the medium support unit 17 in the scanning direction X, for example. In one example, the maintenance unit 30 is located in the second direction A2 with respect to the medium support unit 17. In a case where the liquid ejecting unit 22 is located at a position facing the maintenance unit 30, the maintenance unit 30 receives the liquid discharged from the liquid ejecting unit 22. Specifically, when the liquid ejecting unit 22 is located at the discharge position EP, the maintenance unit 30 receives the liquid discharged from the liquid ejecting unit 22. The discharge position EP is a position at which the liquid ejecting unit 22 faces the maintenance unit 30.

The flushing may be performed in a state where the liquid ejecting unit 22 is stopped at the discharge position EP. The flushing may be performed in a state in which the liquid ejecting unit 22 moves in the first direction A1 during printing. That is, the flushing may be performed while the liquid ejecting unit 22 passes through the discharge position EP during printing.

The maintenance unit 30 includes, for example, a pair of holding rollers 33 and one or more guide rollers 34. The receiving member 32 is wound around the pair of holding rollers 33. The pair of holding rollers 33 holds the receiving member 32. A region of the receiving member 32 held between the pair of holding rollers 33 faces the nozzle surface 25. The receiving member 32 receives the liquid ejected or discharged to this region. Further, the guide roller 34 guides the receiving member 32 together with the pair of holding rollers 33. Accordingly, the receiving member 32 is guided along a predetermined feeding path.

The maintenance unit 30 includes a feeding unit 35 and a winding unit 36. The feeding unit 35 feeds and supplies the unused receiving member 32. The winding unit 36 collects the used receiving member 32 by winding the used receiving member 32. For example, each time the receiving member 32 receives a certain amount of liquid by flushing, the feeding unit 35 and the winding unit 36 rotate. Specifically, the control unit 100 controls the feeding amount per unit of the receiving member 32 by controlling the maintenance unit 30. The liquid ejecting unit 22 moves to the discharge position EP when flushing is necessary. The liquid ejecting unit 22 ejects the liquid from all the nozzles 24 toward the receiving member 32 at the discharge position EP.

The control unit 100 performs feeding control of the receiving member 32 in the maintenance unit 30. The control unit 100 manages the amount of liquid ejected or discharged from the liquid ejecting unit 22 in the cleaning by the liquid ejecting unit 22. Accordingly, the control unit 100 manages the amount of the liquid received in the receiving region horizontally held between the pair of holding rollers 33 in the receiving member 32. When the amount of liquid received in the receiving region of the receiving member 32 exceeds a predetermined threshold value, the control unit 100 controls the winding unit 36. Accordingly, the winding unit 36 winds the receiving member 32 by a predetermined feeding amount. By the winding force of the receiving member 32, the receiving member 32 corresponding to the same feeding amount is fed from the feeding unit 35. In this manner, the receiving member 32 is intermittently fed at each predetermined timing when the amount of liquid received in the receiving region exceeds the threshold value. Accordingly, a used region of the receiving member 32 is switched to an unused region at each predetermined timing.

The time interval of the cleaning period is considerably longer than the time interval of the flushing period. The thickening of the liquid in the nozzle 24 progresses according to the printing length or the printing time. Therefore, the control unit 100 causes the liquid ejecting unit 22 to perform flushing every time the printing length reaches a predetermined unit length during printing or every time the printing time reaches a predetermined unit time. For example, in a period in which there is no liquid discharge operation during printing, the control unit 100 causes the liquid ejecting unit 22 to perform flushing once per unit printing length. The control unit 100 performs a feeding operation of feeding the receiving member 32 once every time the number of times of flushing reaches a predetermined threshold number of times. In addition, the control unit 100 manages, for example, the print length and the elapsed time with the end time point of the previous liquid discharge operation as a start point. The control unit 100 causes the liquid ejecting unit 22 to perform the liquid discharge operation each time one of the print length and the elapsed time reaches each threshold value. When the liquid receiving amount obtained by adding the liquid receiving amount received in the receiving region of the receiving member 32 and the liquid receiving amount by the current liquid discharge operation is equal to or less than the threshold value, the control unit 100 causes the liquid ejecting unit 22 to perform the liquid discharge operation as it is. On the other hand, in a case where the total liquid receiving amount exceeds the threshold value, the control unit 100 causes the winding unit 36 to perform the feeding operation of the receiving member 32 and then causes the liquid ejecting unit 22 to perform the liquid discharge operation. The control unit 100 may manage only one of the print length and the elapsed time. In addition, in a case where the medium 99 is a cut sheet such as cut paper, the control unit 100 may manage the number of printed sheets instead of the print length. In this case, the control unit 100 may cause the liquid ejecting unit 22 to perform the liquid discharge operation with the time when the number of printed sheets reaches a predetermined threshold value as the cleaning time.

During the capping, the nozzle 24 communicate with a substantially closed space surrounded by the nozzle surface 25 and the cap 45C. During capping, the nozzle 24 is moisturized by the vapor of the liquid remaining in the cap 45C. Therefore, the thickening of the liquid in the nozzle 24 is suppressed. During printing, since the liquid ejecting unit 22 is in the non-capping state, the liquid in the nozzle 24 is exposed to the atmosphere. The liquid in the nozzles 24 thickens as a solvent evaporates or volatilizes. During printing, droplets may be ejected from some of the nozzles 24 selected based on the image data among all the nozzles 24. The liquid in the nozzle 24 is refreshed by the ejection of droplets. Meanwhile, the liquid in the non-ejecting nozzle 24 continues to thicken. The liquid in the non-ejecting nozzle 24 is thickened with the printing length or the elapsed time during printing.

Therefore, the control unit 100 manages the flushing timing based on the print length or the elapsed time during printing. The control unit 100 causes the liquid ejecting unit 22 to perform flushing each time the flushing time is reached. For example, in a case where the flushing timing is managed by time, as an example, the flushing timing is set every time a predetermined time (for example, 20 seconds) within a range of 5 to 30 seconds elapses. Flushing may also be performed before and after printing. In this case, the timings before and after the printing are the flushing timings.

The wiping unit 40 includes a wiping member 41. The wiping member 41 is a member that comes into contact with the nozzle surface 25. The wiping member 41 is, for example, cloth. When the wiping member 41 absorbs the liquid adhering to the nozzle surface 25, the liquid is removed from the nozzle surface 25. The wiping unit 40 includes, for example, one or more pressing rollers 42. The pressing roller 42 is a roller that presses the wiping member 41 against the nozzle surface 25. Accordingly, the wiping member 41 can be brought into close contact with the nozzle surface 25. The wiping unit 40 includes, for example, a feeding unit 43 and a winding unit 44. The feeding unit 43 feeds an unused wiping member 41 before being used for wiping. The winding unit 44 collects the used wiping member 41 used for wiping by winding the used wiping member 41. For example, each time the wiping member 41 wipes the nozzle surface 25 a predetermined number of times, the feeding unit 43 and the winding unit 44 rotate.

For example, the contact portion 45 is arranged with the wiping unit 40 in the scanning direction X. In one example, the contact portion 45 is disposed at a position shifted in the second direction A2 from the wiping unit 40. For example, the contact portion 45 faces the nozzle surface 25 when the liquid ejecting unit 22 is located at the retreat position CP. In this state, when the contact portion 45 approaches the liquid ejecting unit 22, the contact portion 45 comes into contact with the nozzle surface 25. The contact portion 45 may come into contact with the nozzle surface 25 by the liquid ejecting unit 22 approaching the contact portion 45.

The contact portion 45 is, for example, the cap 45C that can contact the nozzle surface 25. The cap 45C receives the liquid forcibly discharged from the nozzle 24 of the liquid ejecting unit 22 by the cleaning. The cap 45C is in contact with the nozzle surface 25 to form a substantially closed space communicating with the nozzle 24 between the nozzle surface 25 and the cap 45C. By capping the liquid ejecting unit 22 with the cap 45C, the nozzle 24 communicating with a substantially closed space surrounded by the nozzle surface 25 and the cap 45C is moisturized. Due to this moisturizing action, thickening or drying of the liquid in the nozzle 24 is suppressed. For example, an absorbing member (not illustrated) in which the moisturizing liquid is absorbed may be accommodated in the cap 45C. The moisturizing liquid may be a dedicated moisturizing liquid, or may be liquid such as ink ejected or discharged from the nozzle 24 by the liquid ejecting unit 22.

Further, one of the liquid discharge operation and the flushing may be performed toward the cap 45C. For example, the liquid discharge operation may be performed toward the cap 45C. In this case, the liquid discharge operation may be, for example, pressurization cleaning in which the liquid is forcibly discharged from the nozzle 24 by the pressurizing unit 28 pressurizing the liquid ejecting unit 22. The cap 45C is coupled to a waste liquid accommodating unit (not illustrated) through a discharge tube (not illustrated). By driving a suction pump (not illustrated) provided in the middle of the discharge tube, the liquid (waste liquid) received by the cap 45C is collected in the waste liquid accommodating unit through the discharge tube. The liquid discharge operation may be suction cleaning performed by driving the suction pump in the capping state instead of the pressurization cleaning performed by the pressurizing unit 28. In the suctioning cleaning, a substantially closed space surrounded and formed by the nozzle surface 25 and the cap 45C is set to have a negative pressure by driving the suction pump, and thus the liquid is forcibly discharged from the nozzle 24.

As described above, when the liquid discharge operation is performed toward the cap 45C, the maintenance unit 30 receives only the liquid by the flushing. When the liquid discharge operation is not performed toward the cap 45C, the maintenance unit 30 also receives the liquid by the liquid discharge operation. In the latter case, when the cleaning time comes, the liquid ejecting unit 22 moves to the discharge position EP. In this state, the pressurizing unit 28 pressurizes the liquid ejecting unit 22, and thus the liquid is forcibly discharged from the nozzle 24. The maintenance unit 30 receives the discharged liquid. In FIG. 2, only a part of main components of the maintenance unit 30 is illustrated, and a detailed configuration of the entire maintenance unit 30 will be described below.

### Configuration of Maintenance Unit 30

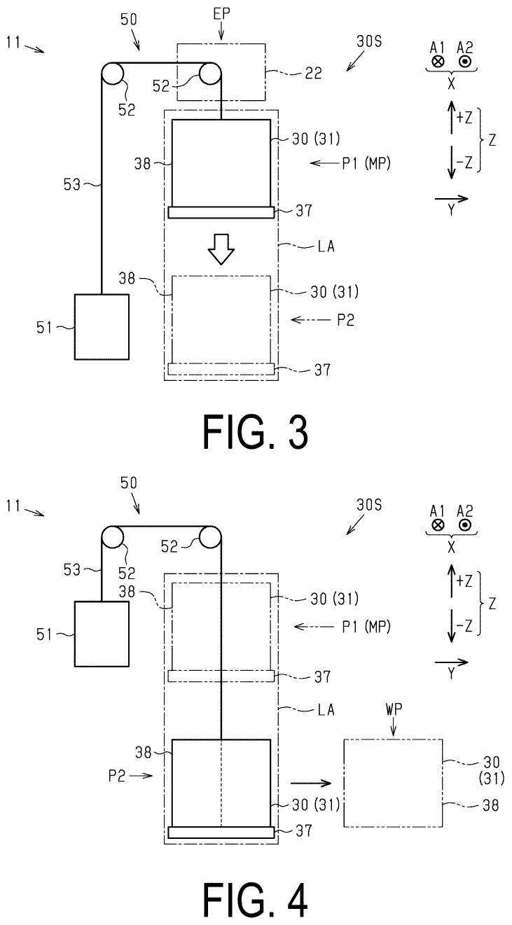

Next, the configuration of a maintenance system 30S including the maintenance unit 30 will be described in detail with reference to FIGS. 3 and 4. The liquid ejecting device 11 includes the maintenance system 30S illustrated in FIGS. 3 and 4. The maintenance system 30S includes the maintenance unit 30 and a raising and lowering mechanism 50. That is, the liquid ejecting device 11 includes the raising and lowering mechanism 50. In FIGS. 3 and 4, the maintenance unit 30 and the raising and lowering mechanism 50 are schematically illustrated. An arrangement position and a detailed configuration of the raising and lowering mechanism 50 will be described below together with the maintenance unit 30. Here, a schematic configuration of the raising and lowering mechanism 50 will be described, and a point that the maintenance unit 30 is configured to be raised and lowered in the raising and lowering region LA by the raising and lowering mechanism 50 will be described.

As illustrated in FIG. 3, the raising and lowering mechanism 50 raises and lowers the maintenance unit 30. Specifically, the raising and lowering mechanism 50 raises and lowers the maintenance unit 30 between a first position P1 and a second position P2 lowered than the first position P1. The Z direction in which the maintenance unit 30 is raised and lowered is also referred to as a raising and lowering direction Z.

In FIG. 3, the maintenance unit 30 is located at the first position P1 raised by the raising and lowering mechanism 50. In FIG. 4, the maintenance unit 30 is located at the second position P2 lowered than the first position P1 by the raising and lowering mechanism 50.

The raising and lowering mechanism 50 includes a counterweight 51 (weight) and a coupling portion 53 having both ends coupled to a coupling destination so as to raise and lower the counterweight 51 and the maintenance unit 30 in opposite directions via a pulley 52. The pulley 52 may be a fixed pulley as illustrated in FIGS. 3 and 4. In this case, the coupling portion 53 couples the counterweight 51 and the maintenance unit 30 via the pulley 52. That is, both ends of the coupling portion 53 are coupled to the counterweight 51 and the maintenance unit 30. The present embodiment is an example in which coupling destinations of both ends of the coupling portion 53 are the counterweight 51 and the maintenance unit 30. The raising and lowering mechanism 50 of the present embodiment includes the counterweight 51, the pulley 52, and the coupling portion 53 configured as described above.

As illustrated in FIGS. 3 and 4, a plurality of pulleys 52 may be provided. As an example, the number of the pulleys 52 is two. One of the two pulleys 52 is located above a coupling portion where the coupling portion 53 suspending the maintenance unit 30 is coupled to the maintenance unit 30. The other of the two pulleys 52 is located above a coupling portion where the coupling portion 53 suspending the counterweight 51 is coupled to the counterweight 51. In this manner, the maintenance unit 30 and the counterweight 51 are fixed to both end portions of the coupling portion 53 passing through the two pulleys 52 in a suspended state. The number of the pulleys 52 is not limited to two, and may be three or more.

In the present embodiment, the weight of the counterweight 51 is large enough to raise the maintenance unit 30 against the weight of the maintenance unit 30. The weight of the counterweight 51 may be greater than the weight of the maintenance unit 30. The counterweight 51 may include a member made of metal.

The coupling portion 53 is a linear member having a predetermined length and flexibility. In the example illustrated in FIG. 3, the coupling portion 53 is a wire. That is, the coupling portion 53 is a wire as an example of a linear member having flexibility. The coupling portion 53 passes through the plurality of pulleys 52, and both end portions thereof are coupled to the maintenance unit 30 and the counterweight 51, respectively. The coupling portion 53 has a strength that can sufficiently withstand even when the coupling portion 53 is pulled from both end portions by gravity due to the weight of each of the maintenance unit 30 and the counterweight 51.

As illustrated in FIG. 3, the maintenance unit 30 includes a support unit 37 and a maintenance portion 38. The maintenance portion 38 is supported by the support unit 37. In the present embodiment, the maintenance unit 30 includes the support unit 37 and the maintenance portion 38 supported by the support unit 37. The support unit 37 is coupled to one end portion of the coupling portion 53. The support unit 37 has, for example, a shape of a support table. The maintenance portion 38 is placed at the support unit 37.

The counterweight 51 is coupled to a first end portion of both end portions of the coupling portion 53, and the support unit 37 is coupled to a second end portion which is an end portion on a side opposite to the first end portion. The support unit 37 is configured to be raised and lowered by raising and lowering of the counterweight 51. The maintenance portion 38 is supported by the support unit 37. The support unit 37 is, for example, a support table. The maintenance portion 38 is placed at the support unit 37 formed of a support base.

The weight of the maintenance unit 30 including the support unit 37 and the maintenance portion 38 is applied to the second end portion side of the coupling portion 53. When the counterweight 51 is raised, the maintenance unit 30 is lowered. When the counterweight 51 is lowered, the maintenance unit 30 is raised.

As illustrated in FIGS. 3 and 4, the maintenance unit 30 of the present embodiment includes the support unit 37 that is raised and lowered by the raising and lowering mechanism 50, and the maintenance portion 38 that is supported by the support unit 37. The maintenance unit 30 of the present embodiment includes the support unit 37 on which the maintenance portion 38 is supported. The weight of the maintenance unit 30 is indicated by the sum of the weight of the maintenance portion 38 and the weight of the support unit 37. The maintenance portion 38 includes the receiving member 32 that is intermittently fed along a predetermined path from the feeding unit 35 toward the winding unit 36. Therefore, the weight of the maintenance portion 38 includes the weight of the receiving member 32. When the weight of the counterweight 51 fixed to both end portions of the coupling portion 53 via the pulley 52 is compared with the weight of the maintenance unit 30, the weight of the counterweight 51 is greater than the weight of the maintenance unit 30.

That is, in the present embodiment, the counterweight 51 has a weight greater than the weight indicated by the sum of the weight of the support unit 37 and the weight of the maintenance portion 38. In addition, the weight of the maintenance portion 38 includes the weight of the liquid received by the receiving member 32 as a result of the maintenance (cleaning). Therefore, the weight of the counterweight 51 may be greater than the total weight of the maintenance unit 30 and the liquid added as a part of the weight of the maintenance unit 30 as a result of the maintenance.

Further, the weight of the maintenance unit 30 includes the weight of various components assembled to the support unit 37. From the above point, the weight of the maintenance unit 30 is defined as all the units in which the weight is applied to the end portion on the side opposite to the coupling side of the counterweight 51 in the coupling portion 53. All of the units include the weights of various components attached to the maintenance portion 38 and the weights of various components attached to the support unit 37.

Therefore, the maintenance unit 30 can be raised from the second position P2 to the first position P1 only by the weight of the counterweight 51. That is, it is possible to automatically raise the maintenance unit 30 from the second position P2 to the first position P1 in a state where there is no operation force of a person. The maintenance unit 30 may be constituted only by the maintenance portion 38 by eliminating the support unit 37. In this case, the counterweight 51 has a weight greater than the weight of the maintenance unit 30 including the maintenance portion 38.

Therefore, a person such as a user or a service person can lower the maintenance unit 30 from the first position P1 to the second position P2 with a small force. The small force is a force against the own weight based on a difference obtained by subtracting the weight of the maintenance unit 30 from the weight of the counterweight 51. In other words, the small force is a force capable of lowering the maintenance unit 30 against its own weight based on a difference obtained by subtracting the weight of the maintenance unit 30 from the weight of the counterweight 51.

When the maintenance unit 30 is lowered in order to perform a predetermined operation on the maintenance unit 30, the maintenance unit 30 can be lowered with a small force due to the weight of the counterweight 51. Further, when the maintenance unit 30 is raised, the maintenance unit 30 can be raised by the weight of the counterweight 51 without applying a force. In addition, since a drive source is not used for raising and lowering the maintenance unit 30, power is not used and control is not required. Therefore, the maintenance system 30S is realized with a simple configuration.

In this manner, the maintenance unit 30 can be raised and lowered in the raising and lowering region LA by the raising and lowering mechanism 50. That is, the maintenance unit 30 is configured to be raised and lowered between the first position P1 and the second position P2 in the raising and lowering region LA. The raising and lowering region LA is a region in which the maintenance unit 30 can be raised and lowered.

The first position P1 illustrated in FIG. 3 is the maintenance position MP at which the maintenance unit 30 performs maintenance. The maintenance position MP is a position at which the maintenance unit 30 performs maintenance on the liquid ejecting unit 22. The maintenance unit 30 performs maintenance on the liquid ejecting unit 22 at the first position P1, which is the raised position. The maintenance unit 30 is disposed at the first position P1 (raised position) which is the maintenance position MP during printing or the like.

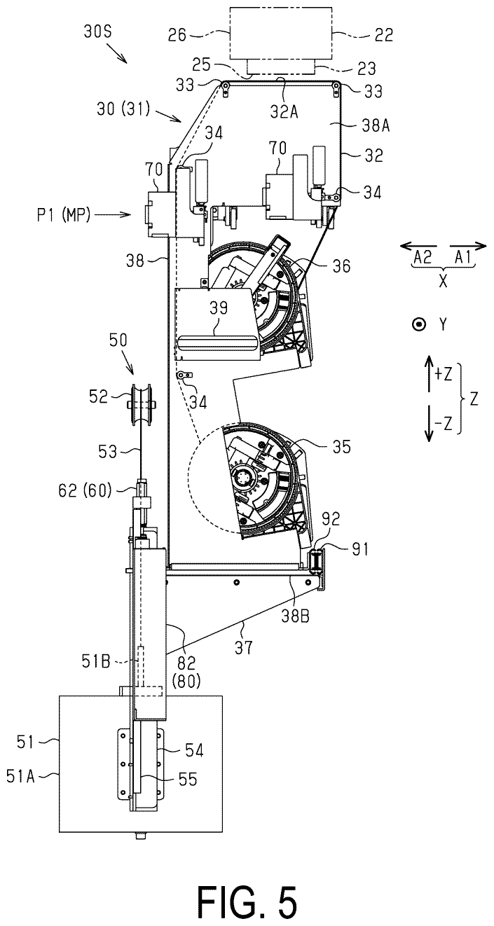

As illustrated in FIG. 4, at least a part of the maintenance unit 30 is slidable along the horizontal direction from the raising and lowering region LA in which the maintenance unit 30 is raised and lowered. In the example illustrated in FIG. 4, at least a part of the maintenance unit 30 is horizontally slidable from the second position P2. At least a part of the maintenance unit 30 is moved to a working position WP by the sliding. The working position WP is a position where, for example, a person such as a user or a service person performs a predetermined operation on at least a part of the maintenance unit 30. The working position WP is, for example, a position where a person performs a predetermined operation such as replacement or replenishment of consumables of the maintenance unit 30. In the present embodiment, the user performs, for example, an operation of replacing the receiving member 32 (see FIGS. 2 and 5) as the predetermined operation.

In FIG. 4, the maintenance portion 38 is supported by the support unit 37. Therefore, the maintenance portion 38 is slidable in the horizontal direction with respect to the support unit 37. That is, the maintenance portion 38, which is a part of the maintenance unit 30, is slidable in the horizontal direction with respect to the support unit 37. The maintenance portion 38 can be pulled out from the support unit 37 to the working position WP by horizontally sliding from the second position P2 with respect to the support unit 37. Since this pull-out direction is parallel to the Y direction, it is also referred to as a pull-out direction Y. The Y direction is also referred to as an intersecting direction Y because the Y direction is also an intersecting direction that intersects the raising and lowering direction Z.

### Configuration of Maintenance System 30S

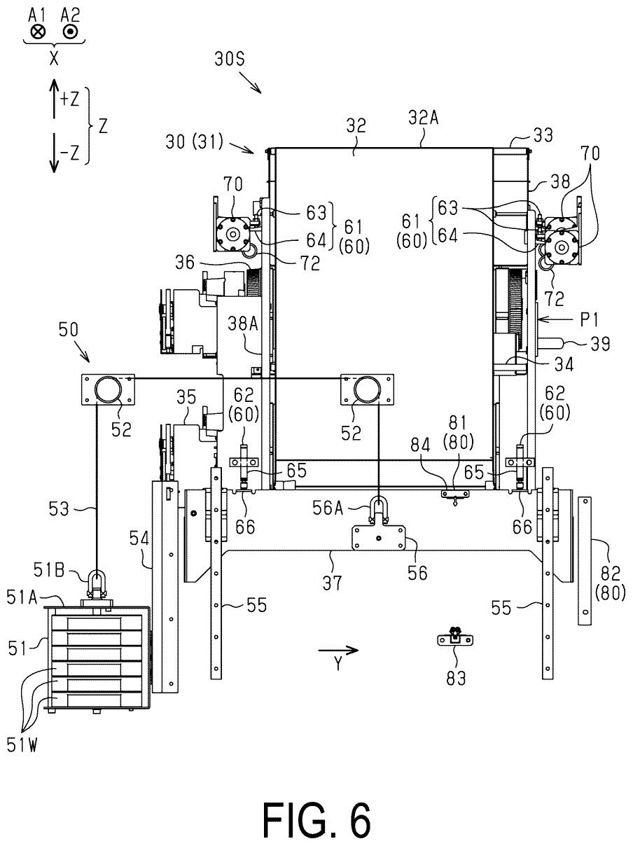

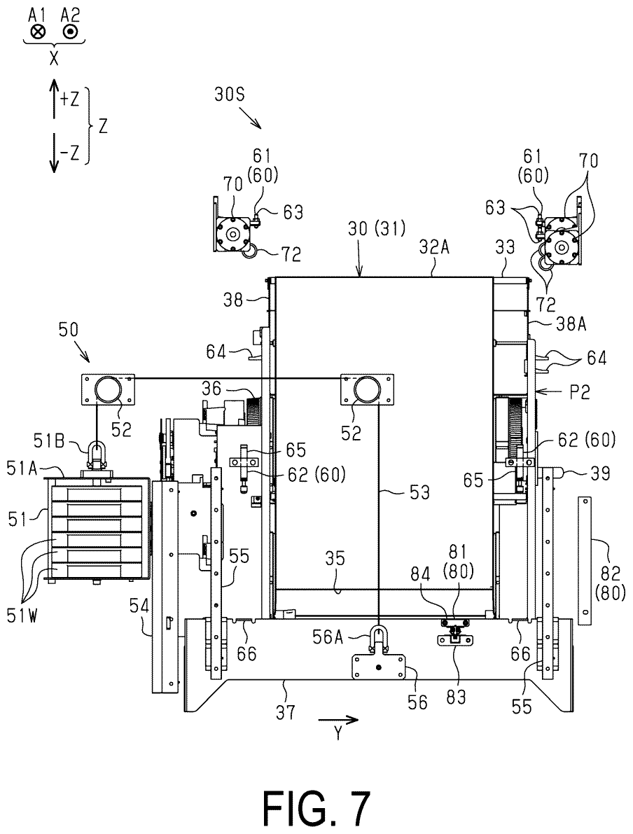

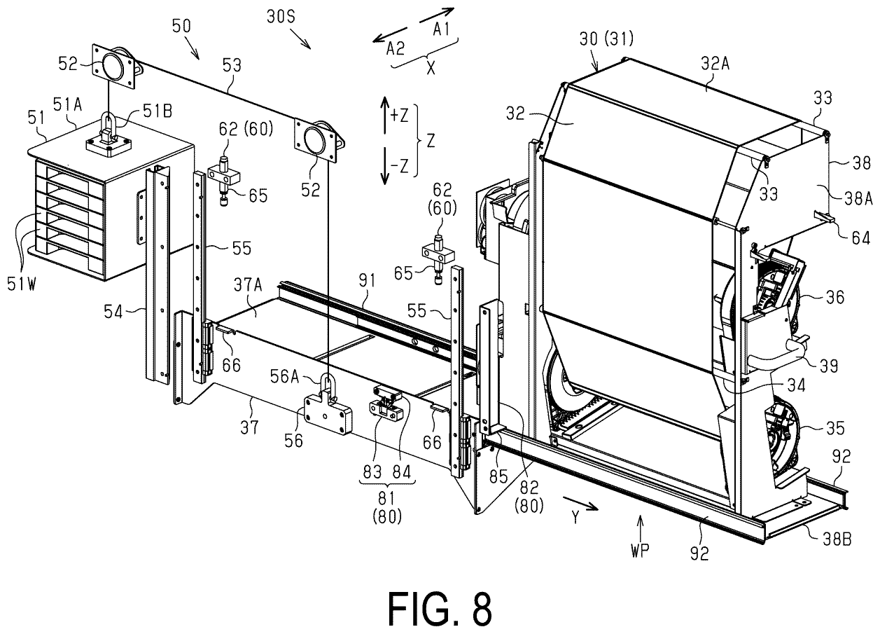

Next, a detailed configuration of the maintenance system 30S will be described with reference to FIGS. 5 to 9. FIG. 5 illustrates a side view from the pull-out side when the maintenance system 30S is pulled out horizontally. FIG. 6 illustrates a state in which the maintenance unit 30 is raised to the first position P1. FIG. 7 illustrates a state in which the maintenance unit 30 is lowered to the second position P2. FIG. 8 illustrates a state in which the maintenance portion 38 is pulled out to the working position WP by sliding the maintenance portion 38 from the support unit 37 in the horizontal direction.

As illustrated in FIG. 5, the maintenance unit 30 includes the feeding unit 35 in which the receiving member 32 that receives liquid is set, and the winding unit 36 that winds the receiving member 32.

The receiving member 32 receives the liquid ejected or discharged from the liquid ejecting unit 22. The liquid ejected from the liquid ejecting unit 22 is liquid ejected from the liquid ejecting unit 22 by flushing. The receiving member 32 receives the liquid ejected from the liquid ejecting unit 22 by flushing. The liquid ejected from the liquid ejecting unit 22 is liquid discharged from the liquid ejecting unit 22 by cleaning. The receiving member 32 receives the liquid discharged from the liquid ejecting unit 22 by cleaning.

The maintenance portion 38 includes a frame 38A. The feeding unit 35 and the winding unit 36 are assembled to the frame 38A. The feeding unit 35 and the winding unit 36 may be disposed vertically. In this case, the winding unit 36 may be disposed above the feeding unit 35. Conversely, the feeding unit 35 may be disposed above the winding unit 36. Since the feeding unit 35 and the winding unit 36 are vertically disposed, the maintenance unit 30 is integrated in a vertically long shape. For example, it is possible to contribute to miniaturization of the liquid ejecting device 11 in the scanning direction X.

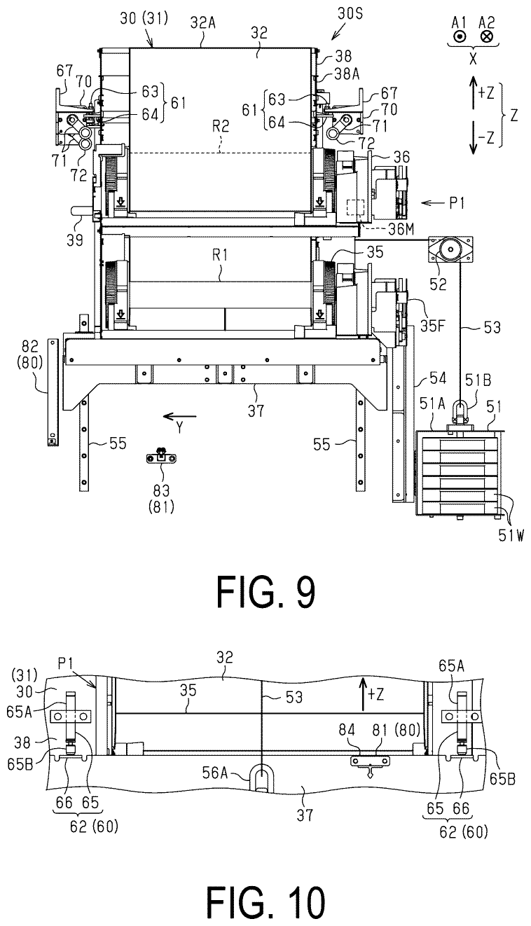

A roll body R1 (refer to FIG. 9) of the receiving member 32 is set in the feeding unit 35. The receiving member 32 is fed from the feeding unit 35 to the winding unit 36. The winding unit 36 winds the receiving member 32 fed from the feeding unit 35 through a predetermined feeding path. The receiving member 32 is guided by the pair of holding rollers 33 and the plurality of guide rollers 34 supported on the frame 38A so as to form a predetermined feeding path. The receiving member 32 forms a receiving region 32A formed of a horizontal surface by a portion guided by the pair of holding rollers 33. The liquid ejecting unit 22 ejects or discharges liquid to the receiving region 32A of the receiving member 32. When the amount of liquid received in the receiving region 32A exceeds the predetermined value, the receiving member 32 is fed by a predetermined feeding amount by driving the winding unit 36. By the feeding operation of the receiving member 32, the receiving region 32A is changed to a new surface.

The winding unit 36 winds the receiving member 32, which has been used by receiving the liquid ejected or discharged from the liquid ejecting unit 22, in a roll shape. The winding unit 36 forms a used roll body R2 (refer to FIG. 9) by winding the used receiving member 32.

### Detailed Configuration of Raising and Lowering Mechanism 50

Next, a detailed configuration of the raising and lowering mechanism 50 will be described with reference to FIGS. 5 to 7. As illustrated in FIGS. 5 to 7, the raising and lowering mechanism 50 is disposed on the back surface side of the maintenance portion 38, which is opposite to the work surface side on which the user performs the replacement operation. As described above, the raising and lowering mechanism 50 includes the counterweight 51, the pulley 52, and the coupling portion 53. The pulley 52 is located at a level that is lower than the level of the surface of the receiving region 32A. Therefore, interference with the liquid ejecting unit 22 can be avoided. Since the coupling portion 53 of the maintenance unit 30 is coupled to the support unit 37, the pulley 52 is disposed at a position lower than the surface of the receiving region 32A.

As illustrated in FIGS. 6 and 7, for example, the two pulleys 52 may be disposed at positions horizontally aligned in the Y direction. The pulley 52 is supported at a predetermined position by a support member (not illustrated). In this manner, the pulley 52 may be a fixed pulley.

The counterweight 51 includes an accommodating unit 51A, a weight 51W, and a first connector 51B. The accommodating unit 51A is configured to accommodate a plurality of the weights 51W. The weight 51W is, for example, a weight plate made of a metallic substance having a large specific weight. The weight of the counterweight 51 can be adjusted by selecting the number of weights 51W accommodated in the accommodating unit 51A. The first connector 51B may be, for example, a U-shaped fitting fixed to the upper surface of the accommodating unit 51A. A first end of the coupling portion 53 is coupled to the first connector 51B of the counterweight 51.

As illustrated in FIGS. 6 and 7, the support unit 37 is supported by a raising and lowering rail 55 in a state in which the support unit 37 can be raised and lowered. The support unit 37 is an elongated member extending in the Y direction. The support unit 37 may be supported by the pair of raising and lowering rails 55 at two positions on both sides in the Y direction.

As illustrated in FIGS. 6 and 7, a coupling member 56 is fixed to the back surface of the support unit 37. The coupling member 56 is fixed to a central portion of the support unit 37 in the Y direction. The coupling member 56 has a second connector 56A. The second connector 56A may be, for example, a U-shaped fitting. A second end portion of the coupling portion 53 is coupled to the second connector 56A of the coupling member 56 fixed to the support unit 37.

One side portion of the counterweight 51 is engaged with a guide rail 54 extending in the vertical direction Z. The counterweight 51 is raised and lowered along the vertical direction Z by being guided by the guide rail 54.

The weight of the counterweight 51 is greater than the weight of the maintenance unit 30. Even if the user does not apply a force to the maintenance unit 30, the maintenance unit 30 is raised to the first position P1 by the weight of the counterweight 51. In other words, the first position P1 is a stable position of the maintenance unit 30. The first position P1 is set as the maintenance position MP. For this reason, it is possible to stably perform maintenance on the liquid ejecting unit 22 by the maintenance unit 30.

When the receiving member 32 of the roll body R1 set in the feeding unit 35 runs out, the user performs a replacement operation of the roll body R1 and the R2 which are consumables. The maintenance unit 30 includes an operation unit 39. The operation unit 39 is provided, for example, on a side surface of a frame 38A of the maintenance portion 38 on the pull-out direction Y side. For example, the user operates the operation unit 39 to apply a downward force to the maintenance unit 30. When a downward force greater than a force corresponding to a difference between the weight of the maintenance unit 30 and the weight of the counterweight 51 is applied, the maintenance unit 30 descends. Here, the weight of the counterweight 51 is denoted by W1, and the weight of the maintenance unit 30 is denoted by W2. The differential AW (W1-W2) is, for example, a predetermined value within a range of 0.1 to 5 kgf. The differential AW may be, for example, a 1 kgf.

The user lowers the maintenance unit 30 from the first position P1, which is the maintenance position MP, to the second position P2. The maintenance unit 30 is lowered than the first position P1 illustrated in FIG. 6 to the second position P2. At this time, the counterweight 51 is raised due to the weight of the maintenance unit 30 and the downward force applied by the user.

As illustrated in FIG. 8, the user slides the maintenance unit 30 at the second position P2 in the pull-out direction Y to move the maintenance unit 30 to the working position WP. As illustrated in FIG. 8, the support unit 37 has a support plate 37A at the bottom. In addition, the maintenance portion 38 has a bottom plate 38B at the bottom. The support unit 37 has a pair of first rails 91 on both sides in the X direction of the support plate 37A. The maintenance portion 38 has a pair of second rails 92 on both sides in the X direction of the bottom plate 38B. The first rail 91 and the second rail 92 are slidably engaged with each other in the Y direction. The maintenance portion 38 at the working position WP is in a state in which the feeding unit 35 and the winding unit 36 are vertically arranged. It is easy for a user to perform a replacement operation of consumables in which the roll body R2 is removed from the winding unit 36 and a new roll body R1 is set in the feeding unit 35.

### Positioning of Maintenance Unit 30 at First Position P1

As illustrated in FIGS. 6 and 7, the liquid ejecting device 11 includes a regulating unit 60 that regulates the maintenance unit 30 from rising from the first position P1.

As illustrated in FIGS. 6 and 7, the maintenance system 30S of the present embodiment includes two types of regulating units 60. The two types of regulating units 60 are a first regulating unit 61 and a second regulating unit 62. The first regulating unit 61 regulates the maintenance unit 30 from being raised from the first position P1. The first regulating unit 61 includes a positioning pin 63 fixed at a predetermined height and a stopper 64 extending horizontally from both side surfaces of the maintenance unit 30 in the Y direction. In the course of raising the maintenance unit 30 to the first position P1, the stopper 64 abuts against the positioning pin 63 when the maintenance unit 30 reaches the first position P1. As a result, the maintenance unit 30 is regulated from further rising from the first position P1. The positioning pin 63 is supported by a distal end portion of a support member 67 (see FIG. 9) fixed to a frame (not illustrated).

At least three first regulating units 61 are provided. In the present embodiment, two first regulating units 61 are provided at each of positions corresponding to both ends of the maintenance unit 30 in the intersecting direction Y intersecting the raising and lowering direction Z. In other words, four first regulating units 61 are provided. As a result, positioning can be reliably performed.

The first regulating units 61 are provided in at least three positions including two positions corresponding to both ends of the maintenance unit 30 in the intersecting direction Y intersecting the raising and lowering direction Z. The at least three positions are defined, for example, as follows. Here, a virtual plane intersecting (for example, orthogonal to) the raising and lowering direction Z is assumed. The virtual plane may be a plane parallel to the nozzle surface 25 of the liquid ejecting unit 22. The at least three positions are positions at which at least three projection positions when projected on a virtual plane intersecting the raising and lowering direction Z are positions corresponding to vertices of a polygon on the virtual plane. That is, the first regulating unit 61 regulates the maintenance unit 30 in at least three positions where a polygon having the respective projection points as vertices can be formed when projected on the virtual plane. If the first regulating unit 61 can regulate the maintenance unit 30 from further rising from the first position P1 in at least three positions, the maintenance unit 30 can be positioned at the first position P1 without being inclined with respect to the horizontal plane.

In the example illustrated in FIGS. 6 and 7, the first regulating units 61 are provided at two positions corresponding to both ends of the maintenance unit 30 in the intersecting direction Y intersecting the raising and lowering direction Z, that is, two positions different in the X direction, that is, four positions in total. The four positions are positions at which the four projection positions when projected onto a virtual plane intersecting the raising and lowering direction Z are positions corresponding to the vertices of a quadrangle on the virtual plane. The first regulating unit 61 regulates the maintenance unit 30 at four positions that can form a quadrangle having the respective projection points as vertices when projected on a virtual plane. Therefore, it is possible to accurately position the maintenance unit 30 with respect to the nozzle surface 25 of the liquid ejecting unit 22. For example, it is possible to position the maintenance unit 30 in a posture in which the surface of the receiving region 32A is parallel to the nozzle surface 25.

The second regulating unit 62 positions the maintenance unit 30 at the first position P1 while absorbing an impact. The second regulating unit 62 includes, for example, a shock absorber 65. Specifically, the second regulating unit 62 includes the shock absorber 65 and a regulating plate 66 formed at the support unit 37. The support unit 37 includes a regulating plate 66 at a position corresponding to the shock absorber 65. At least one second regulating unit 62 is provided. In the present embodiment, two second regulating units 62 are provided at positions corresponding to both ends of the maintenance unit 30 in the intersecting direction Y intersecting the raising and lowering direction Z. Accordingly, it is possible to regulate the lifting of the maintenance unit 30 while reliably absorbing the impact.

One of the two types of regulating units 61, 62 performs main positioning, and the other performs sub-positioning. That is, the second regulating unit 62 absorbs an impact when the maintenance unit 30 is positioned at the first position P1 and is regulated from rising further. On the other hand, the first regulating unit 61 regulates the maintenance unit 30, which is in the course of deceleration in which the impact is absorbed by the second regulating unit 62, to the first position P1.

Further, as illustrated in FIGS. 6 and 7, the maintenance system 30S includes a positioning assist mechanism 70 that assists the maintenance unit 30 to rise until the maintenance unit 30 reaches the first position P1. The positioning assist mechanism 70 assists in raising the maintenance unit 30 to the first position P1 where the raising of the maintenance unit 30 is regulated by the first regulating unit 61. The maintenance unit 30 of the present embodiment rises due to the gravity of the counterweight 51 even if the user does not apply a force. On the other hand, the difference AW is set to be small in order to relatively reduce the operation force applied downward when the user lowers the maintenance unit 30. Therefore, the force for raising the maintenance unit 30 only by the gravity of the counterweight 51 is relatively small according to the difference AW. In addition, in the course of raising the maintenance unit 30, a force that prevents the maintenance unit 30 from rising, such as sliding friction, is generated. As a result, the maintenance unit 30 may not be completely raised to the first position P1. Therefore, in the present embodiment, the positioning assist mechanism 70 assists in raising the maintenance unit 30 to the first position P1. Details of the positioning assist mechanism 70 will be described below.

### Holding of Maintenance Unit 30 at Second Position P2

The liquid ejecting device 11 includes a holding unit 80 that holds the maintenance unit 30 at the second position P2 so that the maintenance unit 30 does not rise from the second position P2. The holding unit 80 includes two types of holding units, namely, a first holding unit and a second holding unit. The first holding unit is, for example, a roll catch 81. The second holding unit is, for example, an uplift prevention member 82.

As illustrated in FIGS. 6 and 7, when the maintenance unit 30 is slid and pulled out with respect to the support unit 37, it is necessary to lock the support unit 37 at the second position P2 so that the support unit 37 does not rise due to the weight of the counterweight 51. The roll catch 81 holds (locks) the support unit 37 at the second position P2. The roll catch 81 includes a first member 83 and a second member 84 that are engageable with each other. The first member 83 is fixed at a predetermined height by a support member (not illustrated). The second member 84 is fixed to the support unit 37 at a predetermined position corresponding to the first member 83.

The uplift prevention member 82 prevents uplift of the maintenance portion 38 in the course of sliding the maintenance portion 38 at the second position P2 to the working position WP or when the maintenance portion 38 is at the working position WP. The detailed configurations of the roll catch 81 and the uplift prevention member 82 will be described below.

### Configuration of Maintenance Portion 38

Next, a configuration of the maintenance portion 38 will be described with reference to FIG. 9. The feeding unit 35 includes a frictional mechanism 35F at an end portion located outside a rotating portion in which the roll body R1 is set. The frictional mechanism 35F generates rotational frictions when the feeding unit 35 rotates. The winding unit 36 includes a motor 36M as a driving source. The winding unit 36 is rotated in the winding direction by the driving force of the motor 36M. The receiving member 32 is wound as the roll body R2 by a winding force of the winding unit 36. The receiving member 32 is fed out from the roll body R1 set in the feeding unit 35 by the winding force of the winding unit 36. At this time, a tensile force is applied to the receiving member 32 by a rotational frictional force generated by the frictional mechanism 35F. By the winding force of the winding unit 36, the receiving member 32 is intermittently fed by a predetermined amount in the feeding direction in a state where tension is applied to the receiving member 32.

### Configuration of Second Regulating Unit 62

Next, the configuration of the second regulating unit 62 will be described with reference to FIG. 10. As illustrated in FIG. 10, the second regulating unit 62 includes the shock absorber 65 and the regulating plate 66 as described above. The shock absorber 65 includes a cylinder 65A and an abutting portion 65B fixed to a distal end portion of a rod biased in a protruding direction in which the rod protrudes from the cylinder 65A. The shock absorber 65 elastically biases the abutting portion 65B in the protruding direction by a biasing force of a spring (not illustrated) in the cylinder 65A, compression air, or the like. When the abutting portion 65B of the shock absorber 65 abuts against the regulating plate 66, the rod of the cylinder 65A elastically contracts against the biasing force in the protruding direction. For this reason, when the abutting portion 65B abuts against the regulation plate 66, the maintenance unit 30 is regulated from rising from the first position P1 while a shock at the time of abutting is alleviated.

### Configuration of First Regulating Unit 61 and Positioning Assist Mechanism 70

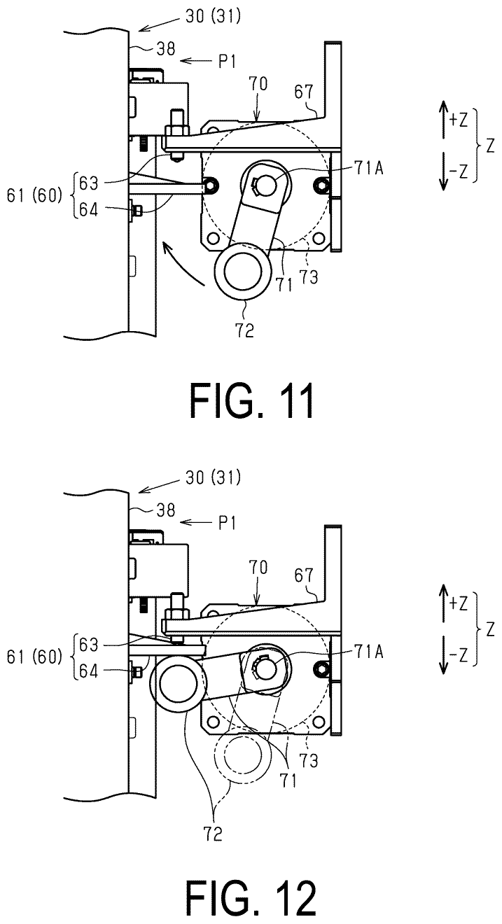

Next, the configurations of the first regulating unit 61 and the positioning assist mechanism 70 will be described with reference to FIGS. 11 and 12. The liquid ejecting device 11 includes the positioning assist mechanism 70 including the positioning member 72 that pushes the maintenance unit 30 to the regulation position where the maintenance unit 30 is regulated by the regulating unit 60. The present embodiment is an example in which the regulation position is the first position P1. This is because the first position P1 is the maintenance position MP. The maintenance position MP is a position at which maintenance is performed on the liquid ejecting unit 22. When the height of the maintenance position MP is shifted in the vertical direction Z, there is a case where the maintenance on the liquid ejecting unit 22 cannot be appropriately performed. For example, when the gap between the nozzle surface 25 of the liquid ejecting unit 22 and the receiving member 32 is large, there is a possibility that the ratio of the liquid that is scattered as mist and cannot be received in the liquid ejected or discharged from the nozzle 24 increases. The scattered liquid contaminates the inside of the housing 12. On the other hand, when the height position of the liquid ejecting unit 22 at the first position P1 is shifted in the upward direction+Z in which the gap is reduced, there is a possibility that the liquid ejecting unit 22 and the receiving member 32 come into contact with each other. In a case where the liquid is color ink, the contact may cause color mixing or damage to the liquid ejecting head 23. Therefore, it is necessary to accurately position the maintenance unit 30 at the first position P1.

As illustrated in FIGS. 11 and 12, the positioning assist mechanism 70 includes an arm 71, a positioning member 72, and a motor 73 as a drive source. The arm 71 is coupled to an output shaft of the motor 73. The positioning member 72 is supported by a distal end portion of the arm 71. When the motor 73 is driven, the arm 71 rotates about a rotation axis 71A within a predetermined angle range. The positioning member 72 may be, for example, a roller rotatably supported by the distal end portion of the arm 71. The arm 71 and the positioning member 72 are located at least at the retracted position illustrated in FIG. 11 during a predetermined period in which the maintenance unit 30 is located within a predetermined range immediately before the maintenance unit 30 reaches the first position P1 in the course of rising.

For example, as illustrated in FIG. 11, the maintenance unit 30 may stop at a position before reaching the first position P1 at which the stopper 64 abuts on the positioning pin 63 due to a force that prevents the maintenance unit 30 from rising, such as sliding friction. When a position sensor (not illustrated) detects that the maintenance unit 30 is positioned within a predetermined range in the course of rising, the control unit 100 drives the motor 73 of the positioning assist mechanism 70. When the motor 73 is driven, the arm 71 and the positioning member 72 are rotated in a pushing direction indicated by an arrow in FIG. 11. As a result, the positioning member 72 performs a pushing operation of pushing the stopper 64 upward.

As illustrated in FIG. 12, when the positioning member 72 performs the pushing operation from the retracted position indicated by the two dot chain line, the stopper 64 is pushed up to the regulation position where the stopper 64 abuts on the positioning pin 63. Therefore, the maintenance unit 30 is reliably positioned at the first position P1.

### Configuration and Operation of Roll Catch 81

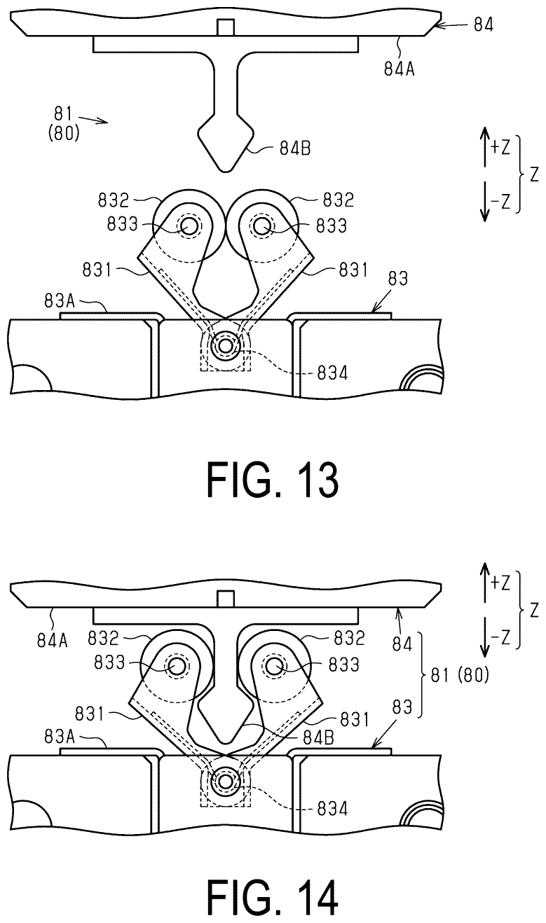

Next, the configuration and operation of the roll catch 81 will be described with reference to FIGS. 13 and 14. FIG. 13 illustrates a separated state in which the first member 83 and the second member 84 constituting the roll catch 81 are not engaged with each other. FIG. 14 illustrates a holding state in which the first member 83 and the second member 84 constituting the roll catch 81 are engaged with each other.

As illustrated in FIG. 13, the second member 84 has a main body 84A and a protruding portion 84B protruding from the main body 84A. A distal end portion of the protruding portion 84B protrudes in a bulging shape, and the bulging portion is formed in a tapered shape that becomes narrower toward a distal end on the first member 83 side.

The first member 83 includes a main body 83A, a pair of swing members 831, a pair of rollers 832, a pair of support shafts 833, and a spring 834. The pair of swing members 831 are rotatably assembled to the main body 83A. The pair of rollers 832 are rotatably attached to distal end portions of the pair of swing members 831. The pair of rollers 832 are rotatable about support shafts 833 respectively fixed to distal end portions of the pair of swing members 831. The spring 834 biases the pair of swing members 831 in a closing direction in which the pair of swing members 831 approach each other. The spring 834 is, for example, a torsion coil spring. Therefore, when the roll catch 81 is in the separated state illustrated in FIG. 13, the pair of rollers 832 is in a closed state. Note that the spring 834 may be a leaf spring or the like. Instead of the support shaft 833, a rotation shaft that is rotatable together with the roller 832 may be used, and the rotation shaft may be rotatably supported by the swing member 831.

When the maintenance unit 30 is at the first position P1, the roll catch 81 is in the separated state illustrated in FIG. 13. When the user lowers the maintenance unit 30 from the first position P1 to the second position P2, as illustrated in FIG. 14, the roll catch 81 enters the holding state. That is, the protruding portion 84B of the second member 84 is inserted between the pair of rollers 832 in the closed state illustrated in FIG. 13 while pushing and expanding the pair of rollers 822. The pair of rollers 832 pinch a thin portion of the protruding portion 84B closer to the base portion than the bulging portion by the biasing force of the spring 834. In this manner, the first member 83 and the second member 84 are engaged with each other as illustrated in FIG. 14. In order to release this engagement, it is necessary to apply a force to spread the pair of rollers 832 to a position wider than the bulging portion of the protruding portion 84B. This force is sufficiently greater than a force f(=ΔW*g) by which the maintenance unit 30 rises due to the weight of the counterweight 51. Here, g is the gravitational acceleration. Therefore, when the roll catch 81 is in the holding state illustrated in FIG. 14, the maintenance unit 30 is held at the second position P2 even if the user does not apply a force.

In the holding state of the roll catch 81 illustrated in FIG. 14, when the user applies a force in the upward direction +Z to the maintenance unit 30, the protruding portion 84B of the second member 84 is detached from the pair of rollers 832. That is, the roll catch 81 is changed from the holding state illustrated in FIG. 14 to the separated state illustrated in FIG. 13. In the separated state of the roll catch 81, the maintenance unit 30 can rise from the second position P2 toward the first position P1.

### Configuration and Operation of Uplift Prevention Member 82

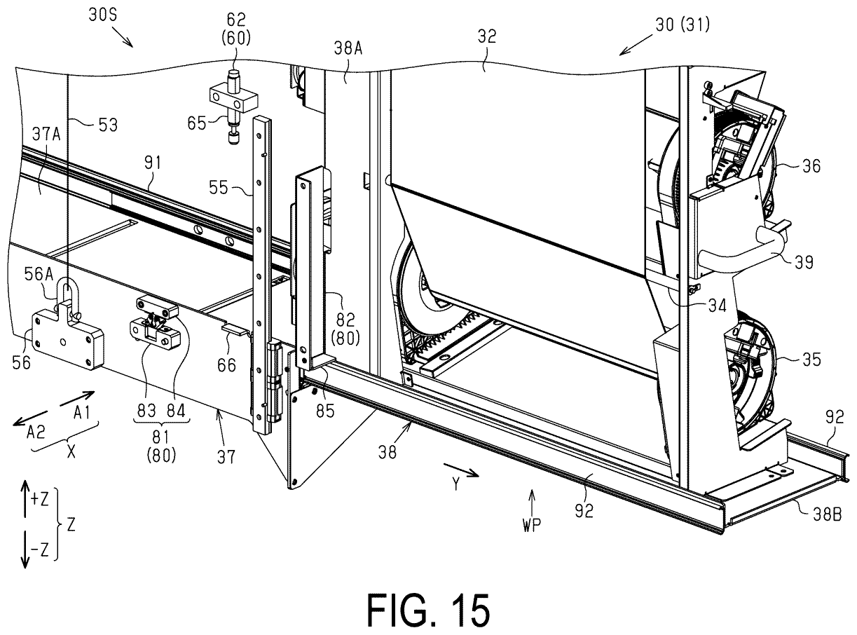

Next, the configuration and operation of the uplift prevention member 82 will be described with reference to FIG. 15. As illustrated in FIG. 15, the uplift prevention member 82 holds the support unit 37 at the second position P2. The uplift prevention member 82 prevents the support unit 37 from uplifting in the upward direction+Z when the user slides the maintenance unit 30 in the intersecting direction Y intersecting the raising and lowering direction Z at the second position P2. The uplift prevention member 82 is disposed at a position deviated in the horizontal direction from a raising and lowering region LA (see FIG. 3) in which the maintenance unit 30 is raised and lowered. Therefore, the uplift prevention member 82 does not prevent the maintenance unit 30 from being raised and lowered. In addition, the uplift prevention member 82 is disposed at a position on the pull-out direction Y side with respect to the support unit 37.

The uplift prevention member 82 has a holding plate 85 at its lower end portion. The lower surface of the holding plate 85 may be formed as, for example, a horizontal holding surface. The holding plate 85 is located at a position slightly higher than the height of a part of the maintenance portion 38 when the holding plate 85 is located at the second position P2. When the maintenance portion 38 is about to float, the holding plate 85 abuts against a part of the maintenance portion 38 to prevent the maintenance portion 38 from uplifting. A part of the maintenance portion 38 that abuts against the holding plate 85 may be a member that is located at a height at which the part can abut against the holding plate 85 and extends in the pull-out direction Y. In the present embodiment, the part of the maintenance portion 38 is, for example, a rail 92 that is fixed to both ends in the X direction of the bottom plate 38B of the maintenance portion 38 and extends in the pull-out direction Y. The uplift prevention member 82 prevents the uplift of the maintenance portion 38 by bringing the rail 92 into contact with the holding plate 85 regardless of the position of the maintenance portion 38 within the sliding range. Therefore, the uplift prevention member 82 prevents the uplift of the maintenance portion 38 in the entire slidable range from the position at which the maintenance portion 38 horizontally deviates from the second position P2 to the working position WP.

For example, when performing a predetermined operation such as an operation of replacing the receiving member 32, the user horizontally slides the maintenance portion 38 located at the second position P2 with respect to the support unit 37. When the maintenance portion 38 is in the middle of sliding or at the working position WP, even if the holding of the roll catch 81 is released for some reason, the uplift of the maintenance portion 38 is regulated by the uplift prevention member 82. Accordingly, the maintenance unit 30 is prevented from uplifting.

A sliding amount by which the maintenance portion 38 is slidable with respect to the support unit 37 is limited to a value at which a state in which a part of the maintenance portion 38 is supported by the support unit 37 is maintained. That is, even when the maintenance portion 38 is located at the working position WP, a part of the maintenance portion 38 is placed at the support unit 37. For this reason, when the maintenance portion 38 is at the working position WP, even if the roll catch 81 is detached, the support unit 37 abuts against the maintenance portion 38 whose upward movement is regulated by the uplift prevention member 82, so that the support unit 37 is prevented from uplifting from the second position P2. That is, when the maintenance portion 38 is at the working position WP, even if the roll catch 81 is disengaged, the maintenance unit 30 is prevented from uplifting from the second position P2.

### Operation and Effects of Embodiment

According to the present embodiment, the following operations and effects are obtained.

(1) The liquid ejecting device 11 includes the liquid ejecting unit 22, the maintenance unit 30, and the raising and lowering mechanism 50. The liquid ejecting unit 22 can eject liquid. The maintenance unit 30 performs maintenance of the liquid ejecting unit 22. The raising and lowering mechanism 50 raises and lowers the maintenance unit 30 between a first position P1 and a second position P2 lowered than the first position P1. The raising and lowering mechanism 50 includes the counterweight 51 and the coupling portion 53. Both ends of the coupling portion 53 are coupled to coupling destinations so as to raise and lower the counterweight 51 and the maintenance unit 30 in opposite directions via the pulley 52. According to this configuration, when the maintenance unit 30 is lowered, the maintenance unit 30 can be lowered by the weight of the counterweight 51 with a small force or without applying a force. Further, when the maintenance unit 30 is raised, the maintenance unit 30 can be raised by the weight of the counterweight 51 without applying a force or with a small force. Therefore, it is possible to improve usability for a person or the like who accesses the maintenance unit 30. For example, in a case where the maintenance unit 30 is moved from the maintenance position MP at which the maintenance of the liquid ejecting unit 22 is performed to the working position WP at which the user performs the work while being lowered or raised, the usability of the user can be improved. In addition, for example, in a case where a driving source is not used, power is not used, and control is not required, and thus, it is possible to realize a simple configuration.

(2) Both ends of the coupling portion 53 are coupled to the counterweight 51 and the maintenance unit 30. According to this configuration, the pulley 52 is a fixed pulley, and the raising and lowering mechanism 50 can be easily realized with a simple configuration. Further, for example, the raising and lowering stroke of the counterweight 51 and the raising and lowering stroke of the maintenance unit 30 can be made equal to each other. For example, in a case where the pulley 52 includes a movable pulley, one of the counterweight 51 and the maintenance unit 30 is coupled to the movable pulley. In this case, the raising and lowering stroke of one of the counterweight 51 and the maintenance unit 30 becomes long, or the weight of the counterweight 51 becomes large. However, the liquid ejecting device 11 can avoid these problems.

(3) The weight of the counterweight 51 is large enough to raise the maintenance unit 30 against the weight of the maintenance unit 30. According to this configuration, the user can lower the maintenance unit 30 located at the first position P1 with a small force. Further, when the maintenance unit 30 is raised from the second position P2, the maintenance unit 30 is raised by the weight of the counterweight 51 without applying a force. Therefore, the usability for the user can be improved.

(4) The weight of the counterweight 51 is greater than the weight of the maintenance unit 30. According to this configuration, since the weight of the counterweight 51 is greater than the weight of the maintenance unit 30, the user can lower the maintenance unit 30 with a small force. Further, the maintenance unit 30 located at the second position P2 is raised by the weight of the counterweight 51 without applying a force. Therefore, the usability for the user can be improved.

(5) The liquid ejecting device 11 includes the regulating unit 60 that regulates the maintenance unit 30 from rising from the first position P1. According to this configuration, the maintenance unit 30 raised by the weight of the counterweight 51 can be positioned at a correct position.

(6) The first regulating unit 61, which is an example of the regulating unit 60, is provided in at least three positions including two positions corresponding to both ends of the maintenance unit 30 in the intersecting direction Y intersecting the raising and lowering direction Z. The at least three positions are positions at which at least three projection positions when projected on a virtual plane intersecting the raising and lowering direction Z are positions corresponding to vertices of a polygon on the virtual plane. According to this configuration, the maintenance unit 30 can be reliably positioned. In particular, it is possible to accurately position the maintenance unit 30 with respect to the nozzle surface 25 which is a surface of the liquid ejecting unit 22 on which maintenance is performed. For example, the maintenance unit 30 can be positioned at the first position P1 (maintenance position MP) in a posture in which the surface of the receiving region 32A is parallel to the nozzle surface 25. That is, it is possible to suppress the surface of the receiving region 32A from being inclined with respect to the nozzle surface 25. Therefore, it is possible to avoid inconvenience in maintenance such as the receiving region 32A coming into contact with the nozzle surface 25 due to the surface of the receiving region 32A being inclined with respect to the nozzle surface 25.

(7) The positioning assist mechanism 70 including the positioning member 72 that pushes the maintenance unit 30 to the regulation position where the maintenance unit 30 is regulated by the first regulating unit 61, which is an example of the regulating unit 60, is provided. According to this configuration, the maintenance unit 30 can be reliably pushed by the positioning member 72 to a position where the maintenance unit 30 comes into contact with the first regulating unit 61. Therefore, the maintenance unit 30 can be more reliably positioned at the first position P1.

(8) The liquid ejecting device 11 includes the holding unit 80 that holds the maintenance unit 30 so that the maintenance unit 30 does not rise from the second position P2. According to this configuration, when the maintenance unit 30 is lowered, the maintenance unit 30 can be held at the second position P2. That is, it is possible to improve the positioning accuracy when the maintenance unit 30 is lowered.

(9) The maintenance unit 30 includes the operation unit 39. According to this configuration, since raising and lowering can be performed by operating the operation unit 39, the usability of the user is improved.

(10) The maintenance unit 30 includes the feeding unit 35 and the winding unit 36. The receiving member 32 that receives the liquid is set in the feeding unit 35. The winding unit 36 winds the receiving member 32. According to this configuration, since the roll of the receiving member 32 can be set in the feeding unit 35, the length of the receiving member 32 set in the feeding unit 35 can be increased. Therefore, it is possible to reduce the replacement frequency or the replenishment frequency of the receiving member 32. In addition, with the roll configuration, since the length of the receiving member 32 can be increased, the maintenance unit 30 is likely to be increased in size and weight. Nevertheless, the above configuration can improve the usability for the user.

(11) The receiving member 32 receives the liquid ejected from the liquid ejecting unit 22. According to this configuration, since it is necessary to replace the receiving member 32 that receives the liquid ejected from the liquid ejecting unit 22, it is possible to improve the usability of the user by adopting the above-described configuration.

(12) The first position P1 is the maintenance position MP at which the maintenance unit 30 performs maintenance. According to this configuration, it is easy to access the maintenance unit 30 by lowering the maintenance unit 30 to a position lowered than the maintenance position MP.

(13) At least a part of the maintenance unit 30 is slidable along the horizontal direction from the raising and lowering region LA in which the maintenance unit 30 is raised and lowered. According to this configuration, at least a part of the maintenance unit 30 can be pulled out in the horizontal direction by sliding. For example, it becomes easier for the user to work on at least a part of the maintenance unit 30.

(14) At least a part of the maintenance unit 30 moves to the working position WP by horizontally sliding from the second position P2. According to this configuration, at least a part of the maintenance unit 30 can be pulled out by sliding. For example, the user can easily perform work on at least a part of the maintenance unit 30.

(15) The maintenance unit 30 includes the support unit 37 and the maintenance portion 38. The support unit 37 is raised and lowered by the raising and lowering mechanism 50. The maintenance portion 38 is supported by the support unit 37. The maintenance portion 38 is slidable in the horizontal direction with respect to the support unit 37. According to this configuration, it is possible to smoothly move the maintenance portion 38, which is a work target of the user, in the horizontal direction when the maintenance portion 38, which is a part of the maintenance unit 30, slides with respect to the support unit 37, rather than when the maintenance unit 30 including the support unit 37 is raised and lowered and slides.

### Modification Examples

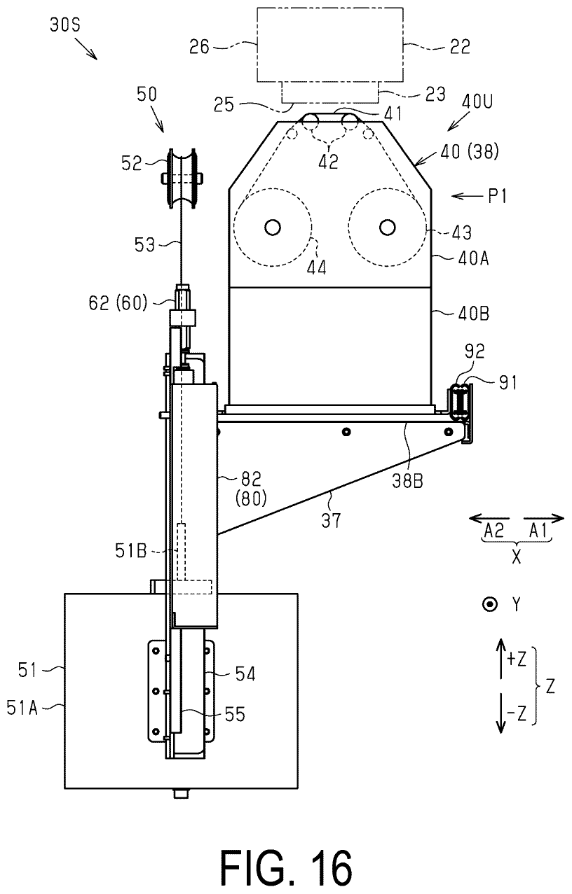

The above embodiment may be modified as follows. Furthermore, the above-described embodiment and the following modification examples can be implemented in combination with each other as long as there is no technical contradiction. Further, the following modification examples can be implemented in combination as appropriate.
The maintenance unit 30 is not limited to the cleaning unit 31. The maintenance unit 30 may be a wiping unit 40U (wiping unit) including the wiping unit 40 illustrated in FIG. 16. That is, the maintenance unit 30 is not limited to the cleaning unit 31, and may be the wiping unit 40U. In this case, as illustrated in FIG. 16, the liquid ejecting device 11 includes the liquid ejecting unit 22 and the maintenance system 30S. The maintenance system 30S includes the wiping unit 40U and the raising and lowering mechanism 50. The wiping unit 40U may include the wiping unit 40 as an example of the maintenance portion 38, and the support unit 37. The support unit 37 supports the wiping unit 40. The receiving member 32 is the wiping member 41 that wipes the liquid adhering to the liquid ejecting unit 22. The wiping unit 40U performs wiping for wiping the nozzle surface 25 of the liquid ejecting unit 22 as maintenance by the wiping unit 40. The wiping unit 40 includes the feeding unit 43 and the winding unit 44. The feeding unit 43, the winding unit 44, the pressing roller 42, and the like are rotatably supported on the frame 40A of the wiping unit 40. The wiping member 41 is pressed upward by the pressing roller 42 at an intermediate portion of the path from the feeding unit 43 to the winding unit 44, and thus a wiping unit capable of wiping the nozzle surface 25 is formed. The wiping unit 40U wipes the nozzle surface 25 with the wiping member 41. The wiping unit 40 may include a raising and lowering unit 40B. The raising and lowering unit 40B raises and lowers the wiping member 41. Accordingly, the wiping member 41 may be configured to be able to come into contact with the nozzle surface 25 of the liquid ejecting unit 22. Alternatively, a configuration may be adopted in which the nozzle surface 25 and the wiping member 41 are brought into contact with each other by lowering the liquid ejecting unit 22 at the discharge position EP.

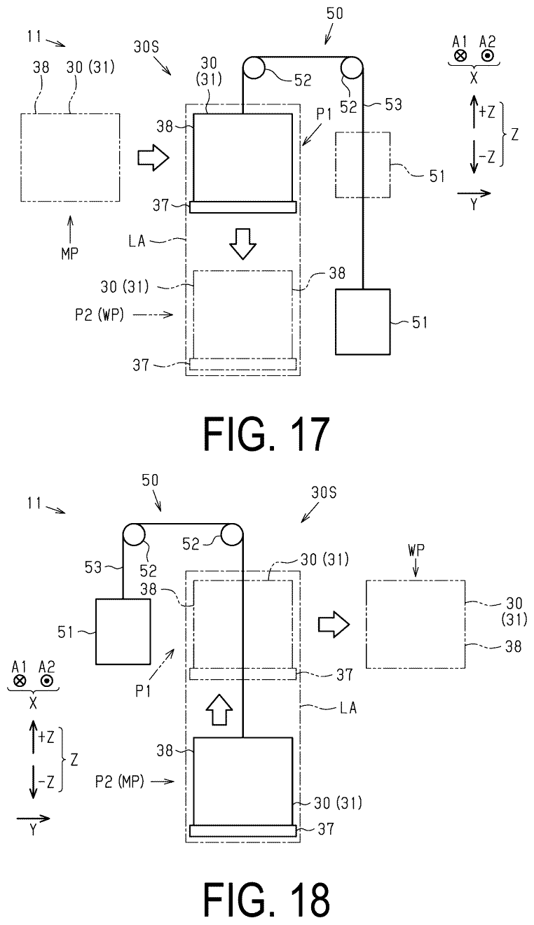

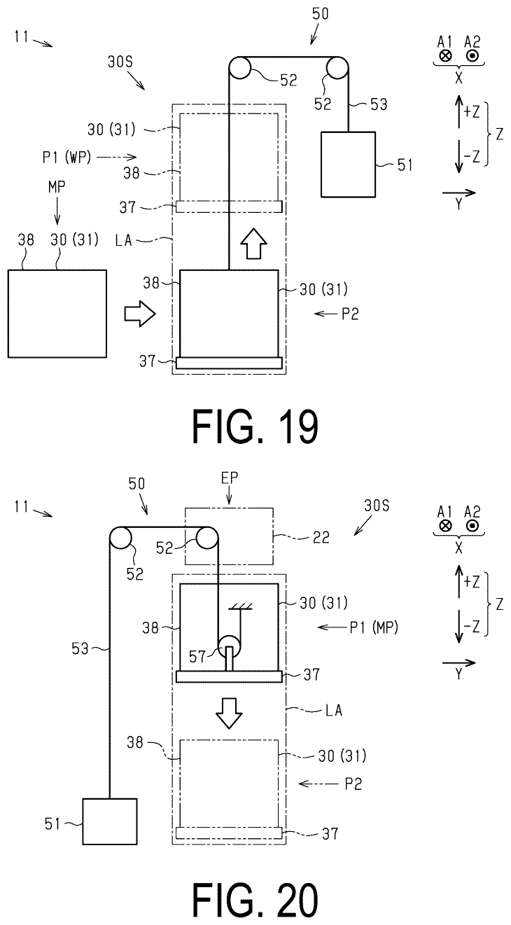

Further, in FIG. 16, the configuration of the raising and lowering mechanism 50 is the same as that of the above-described embodiment. The raising and lowering mechanism 50 raises and lowers the wiping unit 40U between the first position P1 and the second position P2 lowered than the first position P1. That is, the wiping unit 40U is raised and lowered in the raising and lowering region LA (see FIG. 3). The raising and lowering mechanism 50 has the counterweight 51, and the coupling portion 53 whose both ends are coupled to a coupling destination so as to raise and lower the counterweight 51 and the wiping unit 40U in the opposite directions to each other via pulleys 52. Both ends of the coupling portion 53 are coupled to the counterweight 51 and the wiping unit 40U via the pulleys 52. The pulley 52 may be, for example, a fixed pulley. In a case where the wiping unit 40U includes the support unit 37 that supports the wiping unit 40, the second end portion of the coupling portion 53 may be coupled to the support unit 37. The weight of the counterweight 51 may be greater than, smaller than, or the same as the weight of the wiping unit 40U. As an example, the weight of the counterweight 51 may be greater than the weight of the wiping unit 40U. According to this configuration, the wiping unit 40U can be raised to the first position P1 without the user applying a force to the wiping unit 40U. The first position P1 is the maintenance position MP at which the wiping unit 40U wipes the nozzle surface 25 of the liquid ejecting unit 22. In the maintenance system 30S, the configuration other than the configuration in which the maintenance portion 38 is the wiping unit 40 may be the same as that of the above-described embodiment. That is, the maintenance system 30S may include the regulating unit 60, the positioning assist mechanism 70, the holding unit 80, and the operation unit 39 as in the above-described embodiment. In this case, the regulating unit 60 may include two types of regulating units, namely, the first regulating unit 61 and the second regulating unit 62. In addition, the holding unit 80 may include two types of the roll catch 81 and the uplift prevention member 82. Further, the maintenance unit 30 may be slidable along the horizontal direction from the raising and lowering region LA in which the maintenance unit 30 is raised and lowered. That is, the wiping unit 40 may be slidably supported by the rails 91, 92 with respect to the support unit 37. According to the configuration of the modification example, since it is necessary to replace the wiping member 41 that wipes the liquid adhering to the liquid ejecting unit 22, it is possible to improve the usability of the user by employing the above-described configuration.
The maintenance position MP is not limited to the first position P1. For example, as illustrated in FIG. 17, a position outside the raising and lowering region LA may be the maintenance position MP. In this example, the maintenance position MP is located at the same height position as the first position P1 outside the raising and lowering region LA. The maintenance unit 30 is configured to be slidable in the horizontal direction with respect to the raising and lowering region LA. The user may place the maintenance unit 30 at the first position P1 by horizontally sliding the maintenance unit 30 from the maintenance position MP. Further, the position to which the maintenance unit 30 is lowered than the first position P1 to the second position P2 may be the working position WP. For example, the weight of the counterweight 51 may be greater than the weight of the maintenance unit 30. In this case, the user can lower the maintenance unit 30 to the second position P2, which is the working position, with a relatively small downward operating force. In addition, since the maintenance unit 30 is raised without applying a force, it is easy to position the maintenance unit 30 at the first position P1 and the maintenance position MP.
As illustrated in FIG. 18, the maintenance position MP may be the second position P2. That is, in the course of moving the maintenance unit 30 from the maintenance position MP to the working position WP, the maintenance unit 30 may be raised from the second position P2 to the first position P1. In this case, the weight of the counterweight 51 may be smaller than the weight of the maintenance unit 30. The user raises the maintenance unit 30 from the second position P2, which is the maintenance position MP, to the first position P1 by applying an upward force. Further, the user horizontally slides the maintenance unit 30 from the first position P1. Accordingly, the maintenance unit 30 is disposed at the working position WP. In this manner, the working position WP at which the maintenance unit 30 is slid with respect to the raising and lowering region LA may be the same height as the first position P1.
As illustrated in FIG. 19, the maintenance position MP may be a position outside the raising and lowering region LA and at the same height as the second position P2. That is, similarly to FIG. 18, in the course of moving the maintenance unit 30 from the maintenance position MP to the working position WP, the maintenance unit 30 may be raised from the second position P2 to the first position P1. In FIG. 19, the maintenance unit 30 rises from the second position P2 to the first position P1, and then slides horizontally from the first position P1 to be disposed at the working position WP. The weight of the counterweight 51 may be smaller than the weight of the maintenance unit 30. In this manner, the user can raise the maintenance unit 30 with a relatively small operation force.
In the above-described embodiment and the modification examples illustrated in FIGS. 18 and 19, the maintenance portion 38 may not slide in the horizontal direction with respect to the raising and lowering region LA. In this case, for example, in the above embodiment, the second position P2 may be the working position WP. In the modification example illustrated in FIG. 18, the first position P1 may be the working position WP. In the modification example illustrated in FIG. 19, the second position P2 may be the working position WP.
At least one of the pulleys 52 may be a movable pulley. For example, as illustrated in FIG. 20, the maintenance system 30S includes a plurality of pulleys 5257. At least one (for example, one) of them is a movable pulley 57. For example, the movable pulley 57 is coupled to the maintenance unit 30. The coupling portion 53 is provided so as to raise and lower the counterweight 51 and the maintenance unit 30 in opposite directions via the pulleys 52, 57. In the example illustrated in FIG. 20, a first end portion of the coupling portion 53 via the pulleys 52, 57 is coupled to the counterweight 51, and a second end portion which is an end portion on the opposite side of the first end portion via the pulleys 52, 57 is fixed to a predetermined fixing target. The fixing target is, for example, a frame, a support member, or the like in the housing 12. In the example illustrated in FIG. 20, the second end portion of the coupling portion 53 is fixed to the fixing target at a position higher than the highest position of the movable pulley 57 (for example, the position in FIG. 20). The weight of the counterweight 51 may be greater than half of the weight of the maintenance unit 30. In this case, the weight of the moving pulley 57 may be included in the weight of the maintenance unit 30. In short, the weight of the counterweight 51 may be greater than the weight of the counterweight 51 when the counterweight 51 and the maintenance unit 30 are balanced via the pulleys 52, 57 and the coupling portion 53. According to this configuration, the maintenance unit 30 can be raised to the first position P1 by the weight of the counterweight 51 without applying a force. In addition, a force to be applied to the maintenance unit 30 located at the first position P1 when the maintenance unit 30 is lowered is small. Moreover, the weight of the counterweight 51 can be reduced to about a half of the weight of the counterweight 51 in the above embodiment. For example, the total weight of the maintenance system 30S can be reduced. As a result, the total weight of the liquid ejecting device 11 can be reduced. Although the raising and lowering stroke of the counterweight 51 is longer than that in the above-described embodiment, since the maintenance unit 30 has a vertically long shape in which the feeding unit 35 and the winding unit 36 are disposed vertically, it is easy to secure a raising and lowering space.
In the modification example illustrated in FIG. 20, the movable pulley 57 may be fixed to the counterweight 51. According to this configuration, although the weight of the counterweight 51 increases, the raising and lowering stroke thereof can be made smaller than that of the above embodiment. The raising and lowering mechanism 50 may include two movable pulleys 57 to which both the counterweight 51 and the maintenance unit 30 are fixed.
In the modification example illustrated in FIG. 20, the maintenance position MP and the working position WP may be changed as in the modification examples illustrated in FIGS. 16 to 19.
The wiping unit 40 illustrated in FIG. 16 is not limited to a cloth wiper that wipes the nozzle surface 25 with the wiping member 41 made of cloth as an example of the receiving member 32, and may be configured to wipe the nozzle surface 25 with a wiper blade. In this case, adjustment, repair, or replacement of the wiper blade may be performed as the predetermined operation at the working position WP.
The maintenance system 30S in the above-described embodiment and each of the above-described modification examples illustrated in FIGS. 16 to 20 and the like may include at least one of the regulating unit 60, the positioning assist mechanism 70, the holding unit 80, and the operation unit 39. For example, only one of them may be provided, or a plurality of them such as two, three, or four may be provided. Further, the regulating unit 60 may include at least one of the first regulating unit 61 and the second regulating unit 62. Further, the holding unit 80 may include at least one of the roll catch 81 and the uplift prevention member 82.
In the above-described embodiment and the above-described modification examples illustrated in FIGS. 16 to 20 and the like, at least three first regulating units 61 are provided. The number of the first regulating units 61 may be three or five or more. In any case, a polygon having at least three projection points obtained by projecting at least three positions on a virtual plane as vertices is a polygon having three or more vertices. The polygon may be a triangle or a pentagon. Even in these configurations, the maintenance unit 30 can be positioned with high accuracy with little inclination with respect to the nozzle surface 25.
In the above-described embodiment and each of the above-described modification examples illustrated in FIGS. 16 to 20 and the like, only one regulating unit 60 may be provided. In this case, one regulating unit 60 may be provided at a position corresponding to the central portion of the maintenance unit 30 in the intersecting direction Y. Further, three regulating units 60 may be provided at positions corresponding to both sides of the maintenance unit 30 in the intersecting direction Y and a position corresponding to the central portion in the intersecting direction Y. In a case where the maintenance unit 30 is a strong rigid body or is configured to perform maintenance of a type in which positioning accuracy of the liquid ejecting unit 22 with respect to the nozzle surface 25 is not required so much, the number of the first regulating units 61 may be one or two. Further, the number of the second regulating units 62 may be one or three.
In the above-described embodiment and each of the above-described modification examples illustrated in FIGS. 16 to 20 and the like, two holding units 80 may be provided. In this case, the two holding units 80 may be provided at positions corresponding to both sides of the maintenance unit 30 in the intersecting direction Y. For example, two or three roll catches 81 may be provided at different positions in the intersecting direction Y of the maintenance unit 30. In addition, two or three uplift prevention members 82 may be provided at different positions in the intersecting direction Y of the maintenance unit 30.
The positioning assist mechanism 70 may be configured to assist the positioning of the maintenance unit 30 at the second position P2. In this case, the positioning assist mechanism 70 may assist in positioning the maintenance unit 30 at the second position P2 by pushing down the stopper 64 as the pushing operation. This configuration is particularly effective when the second position P2 is the maintenance position MP. In this manner, the pushing by the positioning assist mechanism 70 is not limited to pushing up, and may be pushing down.
In the above-described embodiment and modification examples, the present disclosure is not limited to the configuration in which the maintenance unit 30 is slid in the horizontal direction with respect to the raising and lowering region LA, and the slide mechanism may not be provided in a configuration in which the maintenance unit 30 is not slid.
In the embodiment described above, the receiving member 32, which is an example of a consumable item, is replaced at the working position WP, but the entire maintenance portion 38 may be replaced. In particular, in the small-sized or medium-sized liquid ejecting device 11, since the maintenance portion 38 is small, the maintenance portion 38 may be disposable and replaceable. In this case, since the replacement operation such as roll replacement is not required, the replacement operation is simple.
The maintenance unit 30 may be configured to be slidable in the horizontal direction with respect to the raising and lowering region LA. For example, the pulley 52 may be configured to be movable in the pull-out direction Y in conjunction with the sliding of the maintenance unit 30.
The first position P1 is not limited to the maintenance position MP. The second position P2 may be the maintenance position MP. Further, the working position WP may be a position to which a person or the like raises or lowers the maintenance unit 30 from the maintenance position MP. The working position WP may be a working position to which the maintenance unit 30 is moved from the maintenance position MP along a predetermined path, or the maintenance position MP itself may be the working position.
A subject that performs the predetermined operation at the working position WP is not limited to a person such as a user or a service person, and may be a work robot. In this case, the force required for the work robot can be reduced. For example, the work robot can be reduced in size, weight, and power consumption.
The pulley is not limited to a fixed pulley, and may include a movable pulley. A combined pulley in which a fixed pulley and a movable pulley are combined may be used.
The coupling portion 53 is not limited to a wire. The coupling portion 53 may be a rope, a chain, a chain, or the like. In the case of a chain, the pulley 52 may be a sprocket engageable with the chain.
The receiving member 32 included in the maintenance unit 30 as a consumable item is not limited to cloth. For example, the receiving member 32 may be a liquid absorbing member made of paper or synthetic resin fiber.
The maintenance unit 30 may be configured not to include a consumable such as the receiving member 32. In this case, at the maintenance position MP, a predetermined operation such as maintenance, inspection, or component replacement of the maintenance unit 30 may be performed.
The counterweight 51 may be replaced with a liquid supply source. That is, the counterweight 51 may include a liquid supply source. The liquid supply source may be a liquid supply source for replacement or replenishment, which is prepared in advance for a case where the liquid of the liquid supply source in use that supplies the liquid to the liquid ejecting unit 22 runs out. Examples of the replacement liquid supply source include an ink cartridge. Examples of the liquid supply source for replenishment include an ink bottle. In a configuration in which the liquid ejecting device 11 includes an ink tank as a liquid supply source, a user replenishes the ink tank with liquid (ink) from an ink bottle, for example, when the amount of ink in the ink tank reaches an amount less than the end. The ink cartridge or the ink bottle as a part of the counterweight 51 may be, for example, a new product. However, even if the counterweight 51 is not new, the weight of the counterweight 51 is within a necessary range. The necessary range in the present embodiment is, for example, a range satisfying that the weight of the counterweight 51 is greater than the weight of the maintenance unit 30. As described above, in the configuration in which the spare liquid supply source is stored as a part of the counterweight 51, a storage space for storing the spare liquid supply source can be saved. In addition, the object stored as a part of the counterweight 51 may be a spare consumable necessary for the liquid ejecting device 11 to perform printing. An example of the consumable includes a spare medium 99. In this manner, when the counterweight 51 is substituted with a liquid supply source such as an ink cartridge, an empty space can be effectively used.
The intersecting direction intersecting the raising and lowering direction Z of the maintenance unit 30 may be the X direction instead of the Y direction. In this case, at least three first regulating units 61 may be provided in at least three positions including two positions corresponding to both ends of the maintenance unit 30 in the X direction. Two second regulating units 62 may be provided at positions corresponding to both ends of the maintenance unit 30 in the X direction.
In the above-described embodiment, instead of the maintenance portion 38, the maintenance unit 30 may be configured to be slidable in the horizontal direction with respect to the raising and lowering region LA. For example, a slider on which the lowered maintenance unit 30 can be placed may be disposed at the second position P2, and the slider on which the maintenance unit 30 is placed may move horizontally. In this case, one of the pulleys 52 corresponding to the maintenance unit 30 may move in the horizontal direction together with the maintenance unit 30. Furthermore, the raising and lowering mechanism 50 may also slide in the horizontal direction together with the slider.
The pull-out direction Y of the maintenance portion 38 may be the −Y direction which is a direction opposite to the Y direction, or may be the A1 direction or the A2 direction.
The feeding units 35, 43 constituting the maintenance unit 30 may be driven or active. That is, the feeding units 35, 43 may actively feed the receiving member 32 by being driven by a driving source such as a motor, or may passively feed the receiving member 32 by the winding force of the winding units 36, 44.
The liquid ejecting device 11 may include a drive source that raises and lowers the maintenance unit 30. Even with this configuration, the power required for the drive source is small. Therefore, only a small driving source is required, so that it is possible to reduce the size and cost of the maintenance system 30S. In addition, since the user can raise and lower the maintenance unit 30 without applying an operation force, it is possible to improve usability for the user. According to this configuration, for example, since the user can slide at least a part of the maintenance unit 30 in the horizontal direction without applying an operation force, it is possible to improve usability for the user.
The liquid ejecting device 11 may include a drive source that slides at least a part (for example, the maintenance portion 38) of the maintenance unit 30 along the horizontal direction with respect to the raising and lowering region LA.
The liquid ejecting device 11 may include a nozzle inspection unit that detects an ejection failure of the nozzle 24. The time when the nozzle inspection unit detects the ejection failure of the nozzle 24 may be one of the cleaning times. For example, the nozzle inspection unit drives the piezoelectric element 27 to such an extent that a liquid droplet is not ejected from the nozzle 24, and detects an ejection failure of the nozzle 24 based on residual vibration remaining in the liquid in the liquid chamber communicating with the nozzle 24. The nozzle inspection unit detects a foreign substance, an air bubble, a thickened liquid (for example, thickened ink), or the like in the liquid in the nozzle 24 as the ejection failure of the nozzle 24. The driving element that causes the nozzle 24 to eject liquid droplet is not limited to the piezoelectric element 27, and may be an electrostatic element or a heater element.
The medium 99 is not limited to paper or the like, and may be an envelope, board paper, cloth, a synthetic resin film, a laminate medium, clothing, or the like.
In a case where the liquid ejecting device 11 is a printer, the liquid ejecting device 11 is not limited to the lateral type or the serial type described in the above embodiment, and may be a line type. In the case of the line type, the liquid ejecting unit 22 includes a liquid ejecting head 23 extending in the width direction of the medium 99. Printing is performed on the medium 99 by ejecting the liquid all at once from the nozzles 24 of the long liquid ejecting head 23 toward the medium 99 transported at a constant speed.
The liquid ejecting device 11 is not limited to an ink jet printer that ejects liquid such as ink. The liquid ejecting device 11 may be a device that ejects liquid other than ink. The state of the liquid ejected from the liquid ejecting unit 22 of the liquid ejecting device 11 includes a granular shape, a teardrop shape, and a thread-like shape with a tail. In addition, the liquid referred to here is a material that can be ejected from the liquid ejecting device 11. For example, it is assumed that the liquid may be any matter in a state in which the matter is in a liquid phase, and includes a liquid body having high or low viscosity, and a fluid body such as sol, gel water, other inorganic solvents, an organic solvent, a solution, a liquid resin, and a liquid metal (metal molten liquid). Further, the matter may include one in which particles of a functional material made of a solid such as pigments or metal particles have been dissolved, dispersed, or mixed in a solvent, in addition to a liquid as one state of matter. The ink here includes various liquid compositions such as general aqueous ink and solvent ink, gel ink, and hot-melt ink. Specific examples of the liquid ejecting device 11 include a liquid ejecting device that ejects a liquid containing a material such as an electrode material or a color material used for manufacturing a liquid crystal display, an electroluminescence (EL) display, a surface emitting display, a color filter, or the like in a dispersed or dissolved form. Further, the liquid ejecting device may be a liquid ejecting device that ejects bioorganic substances used for biochip manufacturing, a liquid ejecting device used as a precision pipette and ejecting liquid to be a sample, a dye-printing device, a micro dispenser, or the like. Furthermore, the liquid ejecting device may be a liquid ejecting device that ejects lubricating oil in a pinpoint manner to a precision machine such as a watch or a camera, or a liquid ejecting device that ejects a transparent resin liquid such as an ultraviolet curable resin onto a substrate in order to form a micro hemispherical lens (optical lens) or the like used for an optical communication element or the like. Further, the liquid ejecting device may be a liquid ejecting device that ejects an etching liquid such as an acid or an alkali in order to etch a substrate or the like.

### Supplementary Note

Hereinafter, technical spirits ascertained from the embodiments and the modification examples will be described together with the effects.

(A) A liquid ejecting device includes a liquid ejecting unit configured to eject liquid, a maintenance unit configured to perform maintenance of the liquid ejecting unit, and a raising and lowering mechanism configured to raise and lower the maintenance unit between a first position and a second position lowered than the first position, wherein the raising and lowering mechanism includes a counterweight, and a coupling portion having both ends coupled to a coupling destination to raise and lower the counterweight and the maintenance unit in opposite directions to each other via a pulley. According to this configuration, when the maintenance unit is lowered, the maintenance unit can be lowered by the weight of the counterweight with a small force or without applying a force. Further, when the maintenance unit is raised, the maintenance unit can be raised by the weight of the counterweight without applying a force or with a small force. Therefore, it is possible to improve usability for a person or the like who accesses the maintenance unit. For example, in a case where the maintenance unit is moved from the maintenance position at which the maintenance of the liquid ejecting unit is performed to the working position at which the user performs the work while being lowered or raised, the usability of the user can be improved. In addition, for example, in a case where a driving source is not used, power is not used, and control is not required, and thus, it is possible to realize a simple configuration.

(B) In the liquid ejecting device according to (A), the both ends of the coupling portion may be coupled to the counterweight and the maintenance unit. According to this configuration, since the pulley may be a fixed pulley, it is easy to realize the raising and lowering mechanism with a simple configuration. Further, for example, the raising and lowering stroke of the counterweight and the raising and lowering stroke of the maintenance unit can be made equal to each other. For example, in a case where the pulley includes a movable pulley, one of the counterweight and the maintenance unit is coupled to the movable pulley. In this case, the raising and lowering stroke of one of the counterweight and the maintenance unit becomes long, or the weight of the counterweight becomes large. However, the liquid ejecting device can avoid these problems.

(C) In the liquid ejecting device according to (A), a weight of the counterweight may be large enough to raise the maintenance unit against a weight of the maintenance unit. According to this configuration, the user can lower the maintenance unit located at the first position with a small force. Further, when the maintenance unit is raised from the second position, the maintenance unit is raised by the weight of the counterweight without applying a force. Therefore, the usability for the user can be improved.

(D) In the liquid ejecting device according to (B), a weight of the counterweight may be greater than a weight of the maintenance unit. According to this configuration, since the weight of the counterweight is greater than the weight of the maintenance unit, the user can lower the maintenance unit with a small force. Further, the maintenance unit located at the second position is raised by the weight of the counterweight without applying a force. Therefore, the usability for the user can be improved.

(E) The liquid ejecting device according to any one of (A) to (D) may include a regulating unit configured to regulate rising of the maintenance unit from the first position. According to this configuration, the maintenance unit raised by the weight of the counterweight can be positioned at a correct position.

(F) In the liquid ejecting device according to (E), the regulating unit may be provided in at least three positions including two positions corresponding to both ends of the maintenance unit in an intersecting direction intersecting with a raising and lowering direction, the at least three positions may be positions such that at least three projection positions when projected on a virtual plane intersecting the raising and lowering direction are positions corresponding to vertices of a polygon on the virtual plane. According to this configuration, the maintenance unit can be reliably positioned. For example, it is possible to accurately position the maintenance unit with respect to the surface to be maintained of the liquid ejecting unit.

(G) The liquid ejecting device according to (E) or (F) may include a positioning assist mechanism including a positioning member configured to push the maintenance unit to a regulation position where the maintenance unit is regulated by the regulating unit. According to this configuration, the maintenance unit can be reliably pushed by the positioning member to a position where the maintenance unit comes into contact with the regulating unit. Therefore, the maintenance unit can be more reliably positioned at the first position.

(H) The liquid ejecting device according to any one of (A) to (G) may include a holding unit configured to hold the maintenance unit without allowing the maintenance unit to rise from the second position. According to this configuration, when the maintenance unit is lowered, the maintenance unit can be held at the second position. That is, it is possible to improve the positioning accuracy when the maintenance unit is lowered.

(I) In the liquid ejecting device according to any one of (A) to (H), the maintenance unit may include an operation unit. According to this configuration, since raising and lowering can be performed by operating the operation unit, the usability of the user is improved.

(J) In the liquid ejecting device according to any one of (A) to (I), the maintenance unit may include a feeding unit at which a receiving member configured to receive liquid is set, and a winding unit configured to wind the receiving member. According to this configuration, since the roll of the receiving member can be set in the feeding unit, the length of the receiving member set in the feeding unit can be increased. Therefore, it is possible to reduce the replacement frequency or the replenishment frequency of the receiving member. In addition, with the roll configuration, since the length of the receiving member can be increased, the maintenance unit is likely to be increased in size and weight. Nevertheless, the above configuration can improve the usability for the user.

(K) In the liquid ejecting device according to (J), the receiving member may be configured to receive the liquid ejected from the liquid ejecting unit. According to this configuration, since it is necessary to replace the receiving member that receives the liquid ejected from the liquid ejecting unit, it is possible to improve the usability of the user by adopting the above-described configuration.

(L) In the liquid ejecting device according to (J) or (K), the receiving member may be a wiping member configured to wipe off liquid adhering to the liquid ejecting unit. According to this configuration, since it is necessary to replace the wiping member that wipes the liquid adhering to the liquid ejecting unit, it is possible to improve the usability of the user by employing the above-described configuration.

(M) In the liquid ejecting device according to any one of (A) to (L), the first position may be a maintenance position at which the maintenance unit is configured to perform the maintenance. According to this configuration, it is easy to access the maintenance unit by lowering the maintenance unit from the maintenance position to the lowered position.

(N) In the liquid ejecting device according to any one of (A) to (M), at least a part of the maintenance unit may be configured to slide along a horizontal direction from a raising and lowering region in which the maintenance unit is raised and lowered. According to this configuration, at least a part of the maintenance unit can be pulled out in the horizontal direction by sliding. For example, it becomes easier for the user to work on at least a part of the maintenance unit.

(O) In the liquid ejecting device according to (N), at least a part of the maintenance unit may be configured to move to a working position by sliding from the second position along the horizontal direction. According to this configuration, at least a part of the maintenance unit can be pulled out by sliding. For example, the user can easily perform work on at least a part of the maintenance unit.

(P) In the liquid ejecting device according to (N) or (O), the maintenance unit may include a support unit that is raised and lowered by the raising and lowering mechanism, and a maintenance portion that is supported by the support unit, and the maintenance portion may be configured to slide in the horizontal direction with respect to the support unit. According to this configuration, it is possible to smoothly move the maintenance portion, which is a work target of the user, in the horizontal direction when the maintenance portion, which is a part of the maintenance unit, slides with respect to the support unit, rather than when the maintenance unit including the support unit is raised and lowered and slides.

What is claimed is:

1. A liquid ejecting device comprising:
a liquid ejecting unit configured to eject liquid;
a maintenance unit configured to perform maintenance of the liquid ejecting unit; and
a raising and lowering mechanism configured to raise and lower the maintenance unit between a first position and a second position lowered than the first position, wherein
the raising and lowering mechanism includes:
a counterweight; and
a coupling portion having both ends coupled to a coupling destination to raise and lower the counterweight and the maintenance unit in opposite directions via a pulley.

2. The liquid ejecting device according to claim 1, wherein
the both ends of the coupling portion are coupled to the counterweight and the maintenance unit.

3. The liquid ejecting device according to claim 1, wherein
a weight of the counterweight is large enough to raise the maintenance unit against a weight of the maintenance unit.

4. The liquid ejecting device according to claim 2, wherein
a weight of the counterweight is greater than a weight of the maintenance unit.

5. The liquid ejecting device according to claim 1, comprising a regulating unit configured to regulate rising of the maintenance unit from the first position.

6. The liquid ejecting device according to claim 5, wherein
the regulating unit is provided in at least three positions including two positions corresponding to both ends of the maintenance unit in an intersecting direction intersecting with a raising and lowering direction, and
the at least three positions are positions such that
at least three projection positions when projected on a virtual plane intersecting the raising and lowering direction are positions corresponding to vertices of a polygon on the virtual plane.

7. The liquid ejecting device according to claim 5, comprising a positioning assist mechanism including a positioning member configured to push the maintenance unit to a regulation position where the maintenance unit is regulated by the regulating unit.

8. The liquid ejecting device according to claim 1, comprising a holding unit configured to hold the maintenance unit without allowing the maintenance unit to rise from the second position.

9. The liquid ejecting device according to claim 1, wherein
the maintenance unit includes an operation unit.

10. The liquid ejecting device according to claim 1, wherein
the maintenance unit includes:
a feeding unit at which a receiving member configured to receive liquid is set; and
a winding unit configured to wind the receiving member.

11. The liquid ejecting device according to claim 10, wherein
the receiving member is configured to receive the liquid ejected from the liquid ejecting unit.

12. The liquid ejecting device according to claim 10, wherein
the receiving member is a wiping member configured to wipe off liquid adhering to the liquid ejecting unit.

13. The liquid ejecting device according to claim 1, wherein
the first position is a maintenance position at which the maintenance unit is configured to perform the maintenance.

14. The liquid ejecting device according to claim 1, wherein
at least a part of the maintenance unit is configured to slide along a horizontal direction from a raising and lowering region in which the maintenance unit is raised and lowered.

15. The liquid ejecting device according to claim 14, wherein
at least a part of the maintenance unit is configured to move to a working position by sliding from the second position along the horizontal direction.

16. The liquid ejecting device according to claim 14, wherein
the maintenance unit includes a support unit that is raised and lowered by the raising and lowering mechanism, and a maintenance portion that is supported by the support unit, and
the maintenance portion is configured to slide in the horizontal direction with respect to the support unit.
